(19) United States
(12) Patent Application Publication
(10) Pub. No.: US 2010/0027666 A1
(43) Pub. Date: Feb. 4, 2010

(54) MOTION VECTOR DETECTING APPARATUS, MOTION VECTOR DETECTING METHOD, AND PROGRAM

(75) Inventors: Hiroki TETSUKAWA, Kanagawa (JP); Tetsujiro Kondo, Tokyo (JP); Kenji Takahashi, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/512,426

(22) Filed: Jul. 30, 2009

(30) Foreign Application Priority Data
Jul. 30, 2008 (JP) 2008-196611

(51) Int. Cl. H04N 7/26

(52) U.S. Cl. 375/240.16; 375/E07.123

(57) ABSTRACT

A motion vector detecting apparatus includes an evaluation value information forming unit to form evaluation value information of motion vectors evaluating a possibility that a reference pixel is a candidate motion of a target pixel on the basis of pixel value correlation information between the target pixel in one of frames on a time axis in moving image data and the reference pixel in a search area in another of the frames, perform counting on at least one of the target pixel and reference pixel when a strong correlation is determined on the basis of the pixel value correlation information, and determine an evaluation value to be added to the evaluation value information on the basis of a count value obtained through the counting; a motion vector extracting unit to extract candidate motion vectors; and a motion vector determining unit to determine a motion vector among the candidate motion vectors.

### BACKGROUND OF THE INVENTION

1. Field of the Invention

The present invention relates to a motion vector detecting apparatus and a motion vector detecting method preferably applied to detect motion vectors from moving image data and perform image processing such as high-efficiency coding. Also, the present invention relates to a program of executing a motion vector detecting process.

2. Description of the Related Art

Hitherto, in the field of moving image processing, efficient image processing has been performed with the use of motion information, i.e., temporally-varying magnitude and direction of a motion of an object in an image. For example, a motion detection result is used in motion-compensating interframe coding in high-efficiency coding of an image or in parameter control by a motion in a television noise reducing apparatus by an interframe time region filter. A block matching method has been used as a method for calculating a motion in a related art. In the block matching method, an area where a motion occurs is searched for in units of blocks in a frame of image, each block being composed of a predetermined number of pixels. A motion vector detecting process based on the block matching method is the most popular general process as image processing using motion vectors, which has been in practical use in the MPEG (Moving Picture Experts Group) method or the like.

However, the block matching method, which is executed in units of blocks, does not necessarily detect a motion in an image in each frame with high accuracy. Accordingly, the applicant of the present application has suggested a motion vector detecting process described in Patent Document 1 (Japanese Unexamined Patent Application Publication No. 2005-175869). In this motion vector detecting process, evaluation values about motions at respective pixel positions are detected from an image signal, the detected evaluation values are held in an evaluation value table, and a plurality of candidate vectors in one screen are extracted from data of the evaluation value table. Then, the correlation of interframe pixels associated by the extracted candidate vectors is determined in each pixel on the entire screen. Then, the candidate vector that connects the pixels having the strongest correlation is determined to be a motion vector for the pixels. Details of this process are described below in embodiments.

FIG. 28 illustrates a configuration of the previously-suggested evaluation value table forming unit in the case of determining a motion vector by using the evaluation value table. In the configuration illustrated in FIG. 28, an image signal obtained at an input terminal 1 is supplied to a correlation operating unit 2. The correlation operating unit 2 includes a reference point memory 2a, a target point memory 2b, and an absolute value calculating unit 2c. The image signal obtained at the input terminal 1 is first stored in the reference point memory 2a, and the data stored in the reference point memory 2a is transferred to the target point memory 2b, so that the reference point memory 2a and the target point memory 2b store pixel signals having a difference of one frame. Then, a pixel value of a target point in the image signal stored in the target point memory 2b and a pixel value at a pixel position selected as a reference point in the image signal stored in the reference point memory 2a are read, and the difference between the both pixel values is detected by the absolute value detecting unit 2c. Data of the absolute value of the detected difference is supplied to a correlation determining unit 3. The correlation determining unit 3 includes a comparing unit 3a, which compares the data of the absolute value of the detected difference with a set threshold, and obtains an evaluation value. As the evaluation value, a correlation value can be used for example. When the difference is equal to or smaller than the threshold, it is determined that the correlation is strong.

The evaluation value obtained in the correlation determining unit 3 is supplied to an evaluation value table calculating unit 4, where an evaluation value integrating unit 4a integrates the evaluation value and an evaluation value table memory 4b stores an integration result. Then, the data stored in the evaluation value table memory 4b is supplied as evaluation value table data from an output terminal 5 to a circuit in a subsequent stage.

FIGS. 29A and 29B illustrate an overview of a processing state of determining a motion vector by using the evaluation value table according to the related art illustrated in FIG. 28. As illustrated in FIG. 29A, a pixel position serving as a basis to determine a motion vector in a preceding frame F0, which is image data of the preceding frame of a present frame F1, is set as a target point d0. After the target point d0 has been set, a search area SA in a predetermined surrounding range of the pixel position at the target point d0 is set in the present frame F1. After the search area SA has been set, evaluation values are calculated with respective pixels in the search area SA being set as a reference point d1, and the evaluation values are registered in the evaluation value table. Then, the reference point having the largest evaluation value in the search area SA among the evaluation values registered in the evaluation value table is determined to be a pixel position in the present frame F1 corresponding to a motion from the target point d0 in the preceding frame F0. After the reference point having the largest evaluation value has been determined in this way, a motion vector “m” is determined on the basis of a motion quantity between the reference point having the largest evaluation value and the target point, as illustrated in FIG. 29B.

In this way, a motion vector can be detected on the basis of the evaluation value table data through the process illustrated in FIGS. 28, 29A, and 29B.

### SUMMARY OF THE INVENTION

In the case where a motion vector is detected on the basis of the evaluation value table data, a determination of an optimum motion vector depends on the performance of the evaluation value table. In the method according to the related art illustrated in FIGS. 29A and 29B, the correlation between the target point and a pixel corresponding to a candidate motion in the search area in a further frame (present frame) is determined. More specifically, if an absolute value of a difference in luminance value is equal to or smaller than a threshold, a candidate motion is counted in the evaluation value table.

However, in this process according to the related art, the following problem may arise. That is, if the evaluation value table is formed through only the above-described correlation determination in an image where a spatial inclination hardly exists in all or part of directions at a flat portion or in a stripe pattern, a false motion can be added, which decreases the reliability of the evaluation value table. The decreased reliability of the evaluation value table causes a decreased accuracy of detecting a motion vector.

In the evaluation value table according to the related art, a false motion may be added if a plurality of motions occur in an image. Thus, evaluation values resulting from respective motions are buried, which makes it difficult to detect respective motion vectors.

The present invention has been made in view of the above-described problems, and is directed to enhancing the accuracy of detecting motion vectors by using an evaluation value table. Also, the present invention is directed to detecting a plurality of motions when the plurality of motions occur.

Embodiments of the present invention are applied to detect motion vectors from moving image data.

In the processing configuration, a process of generating evaluation value information, a process of extracting motion vectors on the basis of the evaluation value information, and a process of determining a motion vector among the extracted candidate motion vectors are performed.

In the process of generating the evaluation value information, when strong correlation is determined on the basis of pixel value correlation information, counting is performed on at least any one of a target pixel and a reference pixel. Then, an evaluation value to be added to the evaluation value information is determined on the basis of a count value obtained by the counting, whereby the evaluation value information is formed.

According to an embodiment of the present invention, in the case where the count value of the target pixel or the reference pixel having a high correlation value to be a candidate motion vector exceeds a threshold, many false candidates exist. In this state, the possibility that a false candidate motion vector is detected is very high.

That is, assume an ideal state where an object displayed at a specific position in a frame of image moves at one portion in another frame, and motion vectors are correctly detected without any false. In this state, the target pixel and the reference pixel correspond to each other in a one-to-one relationship. Thus, when a pixel at a specific position is selected as a candidate reference pixel from among many target pixels over a threshold, many false candidate motion vectors exist. Likewise, when many candidate target pixels with respect to a reference pixel exist, many false candidate motion vectors exist. Thus, if a process of determining a motion vector is performed by using the pixel as a candidate reference pixel or a candidate target pixel, the possibility that a motion vector detection of low reliability with reference to wrong information is performed is high.

In an embodiment of the present invention, when a count value indicating the number of pixels at respective positions serving as a candidate of a target pixel or reference pixel exceeds the threshold, it is determined that many false candidates exist, and the candidates are eliminated. Accordingly, only candidates of motion detection having a certain degree of accuracy remain, so that an appropriate evaluation value table used to detect motion vectors can be obtained.

According to an embodiment of the present invention, when an evaluation value table indicating the distribution of a correlation determination result is generated, a state where candidates over a threshold are counted can be excluded in a process of comparing a count value of candidates and the threshold, so that an appropriate evaluation value table can be obtained. That is, a state where many pixels at certain positions are selected as a candidate of a target pixel or reference pixel is excluded because many false candidates are included, so that appropriate candidate evaluation values can be obtained and that an appropriate evaluation value table can be obtained. Accordingly, false motions due to pixels in a flat portion or in a repeated pattern of an image can be reduced, a highly-reliable evaluation value table can be generated, and the accuracy of detected motion vectors can be enhanced. Also, even if a plurality of motions occur in a search area, evaluation values of the respective motions can be appropriately obtained, and the plurality of motions can be simultaneously calculated.

### BRIEF DESCRIPTION OF THE DRAWINGS

FIG. 1 is a block diagram illustrating an example of a configuration of a motion vector detecting apparatus according to a first embodiment of the present invention;

FIG. 2 is a flowchart illustrating an example of an entire process according to the first embodiment;

FIG. 3 is a block diagram illustrating an example of a configuration of an evaluation value table forming unit according to the first embodiment, in which pixels are discriminated by using a matching number of target and reference points;

FIG. 4 is a flowchart illustrating a process performed by the configuration illustrated in FIG. 3;

FIG. 5 illustrates the relationship between a reference point and a target point in the configuration illustrated in FIG. 3;

FIGS. 6A and 6B illustrate an overview of a matching number in the configuration illustrated in FIG. 3;

FIGS. 7A and 7B illustrate an example of a test image;

FIG. 8 illustrates an example of a histogram of the matching number in the configuration illustrated in FIG. 3;

FIG. 9 is a characteristic diagram illustrating an example of evaluation value table in the case where discrimination based on the matching number is not performed;

FIG. 10 is a characteristic diagram illustrating an example of evaluation value table in the case where discrimination based on the matching number is performed with a fixed threshold according to the first embodiment;

FIG. 11 is a characteristic diagram illustrating an example of evaluation value table in the case where discrimination based on the matching number is performed by using a mode as threshold according to the first embodiment;

FIG. 12 is a block diagram illustrating an example of a configuration of an evaluation value table forming unit according to a second embodiment of the present invention, in which pixels are discriminated by using a matching number of target and reference points and a spatial inclination pattern;

FIG. 13 is a flowchart illustrating a process performed by the configuration illustrated in FIG. 12;

FIGS. 14A and 14B illustrate a spatial inclination pattern and a spatial inclination code of a reference point and a target point;

FIG. 15 illustrates examples of the spatial inclination code according to the second embodiment;

FIG. 16 illustrates an example of the spatial inclination pattern according to the second embodiment;

FIG. 17 illustrates an example of a histogram of the matching number in the configuration illustrated in FIG. 12;

FIG. 18 is a characteristic diagram illustrating an example of evaluation value table in the case where discrimination based on the matching number is performed according to the second embodiment;

FIG. 19 is a characteristic diagram illustrating an example of evaluation value table in the case where discrimination based on the matching number is performed by using a mode as threshold according to the second embodiment;

FIG. 20 is a characteristic diagram illustrating an example of evaluation value table in the case where discrimination based on the matching number is performed by using a weighted average as threshold according to the second embodiment;

FIG. 21 is a block diagram illustrating an example of a configuration of an evaluation value table forming unit according to a third embodiment of the present invention, in which pixels are discriminated by weighting using a matching number of target and reference points;

FIG. 22 is a flowchart illustrating a process performed by the configuration illustrated in FIG. 21;

FIG. 23 is a block diagram illustrating an example of a configuration of the motion vector extracting unit illustrated in FIG. 1;

FIG. 24 is a flowchart illustrating a process performed by the configuration illustrated in FIG. 23;

FIG. 25 is a block diagram illustrating an example of a configuration of a motion vector determining unit illustrated in FIG. 1;

FIG. 26 is a flowchart illustrating a process performed by the configuration illustrated in FIG. 25;

FIG. 27 illustrates an example of a motion vector determining process performed by the configuration illustrated in FIG. 25;

FIG. 28 is a block diagram illustrating an example of a configuration of an evaluation value table forming unit according to a related art; and

FIGS. 29A and 29B illustrate an overview of an example of an evaluation value table forming process according to the related art.

### DESCRIPTION OF THE PREFERRED EMBODIMENTS

### 1. Overview of Entire Configuration to Detect Motion Vector

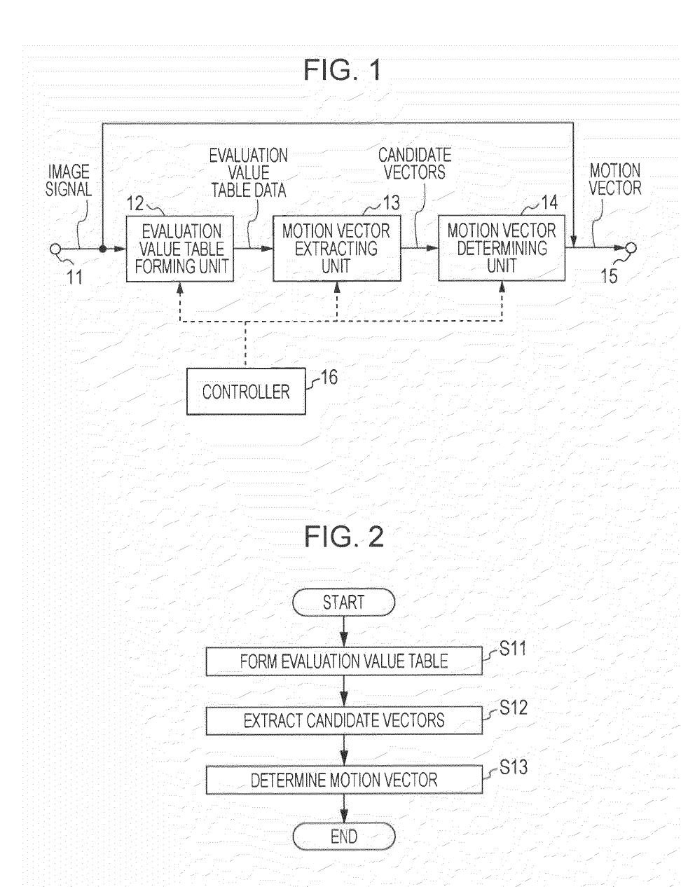

A first embodiment of the present invention is described with reference to FIGS. 1 to 11.

In this embodiment, a motion vector detecting apparatus detects a motion vector from moving image data. In a detecting process, an evaluation value table is formed on the basis of pixel value correlation information, data of the evaluation value table is integrated, whereby a motion vector is determined. In the following description, a table storing evaluation value information of motion vectors is called “evaluation value table”. The evaluation value table is not necessarily configured as stored information in a table form, and any form of information indicating evaluation values of motion vectors can be accepted. For example, information of evaluation values may be expressed as a histogram.

FIG. 1 illustrates an entire configuration of the motion vector detecting apparatus. An image signal obtained at an image signal input terminal 11 is supplied to an evaluation value table forming unit 12, which forms an evaluation value table. The image signal is a digital image signal in which individual luminance values can be obtained in respective pixels in each frame, for example. The evaluation value table forming unit 12 forms an evaluation value table having the same size as that of a search area.

Data of the evaluation value table formed by the evaluation value table forming unit 12 is supplied to a motion vector extracting unit 13, which extracts a plurality of candidate motion vectors from the evaluation value table. Here, the plurality of candidate vectors are extracted on the basis of a peak emerging in the evaluation value table. The plurality of candidate vectors extracted by the motion vector extracting unit 13 are supplied to a motion vector determining unit 14. The motion vector determining unit 14 determines, by area matching or the like, the correlation of interframe pixels associated by candidate vectors in units of pixels in the entire screen for the candidate vectors extracted by the motion vector extracting unit 13. Then, the motion vector determining unit 14 sets the candidate vector connecting the pixels or blocks having the strongest correlation as a motion vector corresponding to the pixels. The process of obtaining a motion vector is executed under control by a controller 16.

Data of the set motion vector is output from a motion vector output terminal 15. At this time, the data may be output while being added to the image signal obtained at the input terminal 11 as necessary. The output motion vector data is used in high-efficiency coding of image data, for example. Alternatively, the output motion vector data may be used in a high image quality process to display images in a television receiver. Furthermore, the motion vector detected in the above-described process may be used in other image processing.

### 2. Overview of Entire Process to Detect Motion Vector

The flowchart in FIG. 2 illustrates an example of a process to determine a motion vector. First, an evaluation value table is formed on the basis of an input image signal (step S11), and a plurality of candidate vectors are extracted from the evaluation value table (step S12). Among the plurality of extracted candidate vectors, the motion vector of the strongest correlation is determined (step S13). The process along the flowchart in FIG. 2 is executed for each frame. The configuration described above is a general configuration as a motion vector detecting configuration using the evaluation value table.

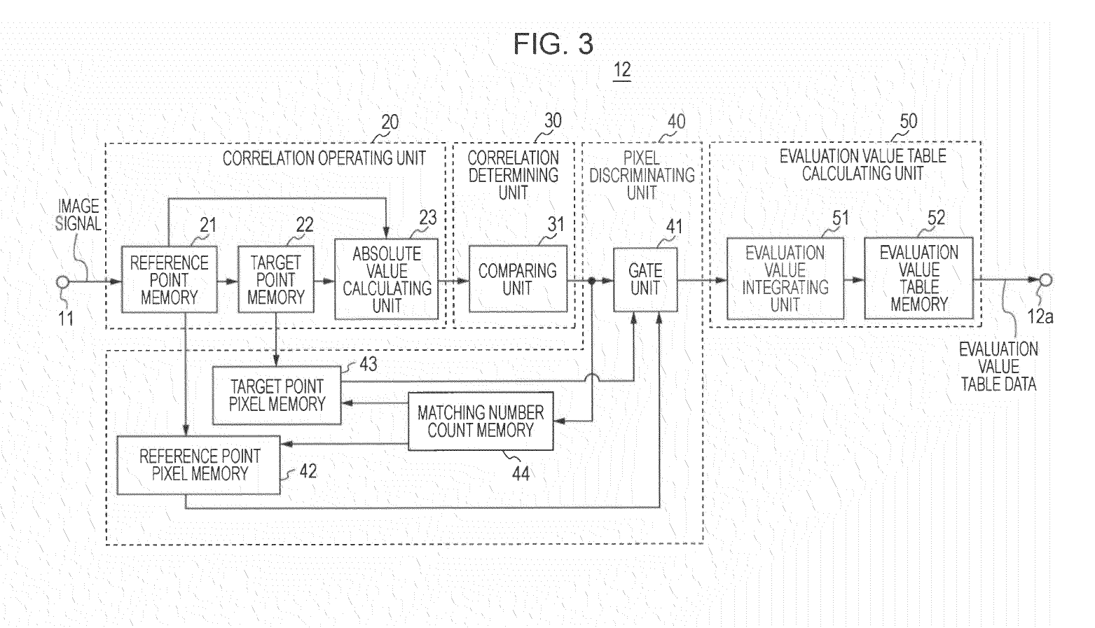

In this embodiment, the evaluation value table forming unit 12 has the configuration illustrated in FIG. 3 to form the evaluation value table. In the example illustrated in FIG. 3, the number of times when pixel positions of a target point and a reference point are set as a candidate of a target point or a reference point is counted at formation of the evaluation value table, and pixels are discriminated on the basis of a result of the counting. Here, the target point is a pixel position (target pixel) serving as a basis to determine a motion vector. The reference point is a pixel position (reference pixel) at a point that can be a destination of motion from the target point. The reference point is a pixel near the pixel position of the target point (i.e., in the search area) in the subsequent or preceding frame of the frame including the target point.

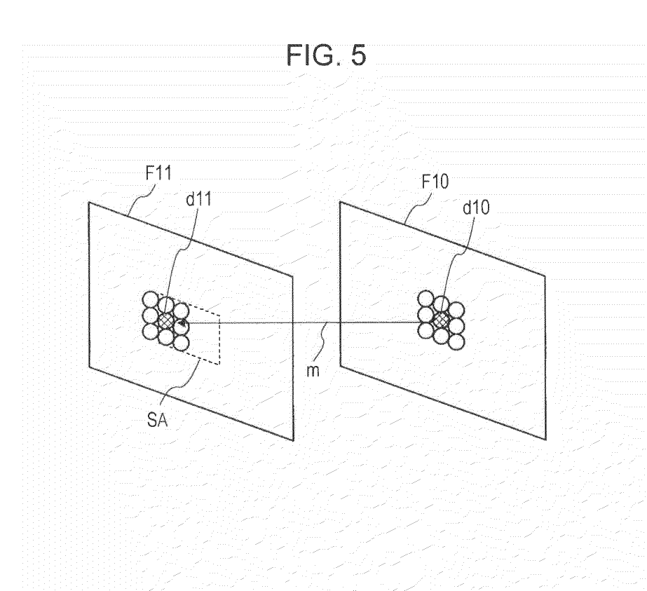

Before describing the configuration illustrated in FIG. 3, which is a characteristic of this embodiment, the relationship between the target point and the reference point is described with reference to FIG. 5.

As illustrated in FIG. 5, a pixel position serving as a basis to determine a motion vector in a preceding frame F10, which is image data of the preceding frame of a present frame F11, is set as a target point d10. After the target point d10 has been set, a search area SA in a predetermined surrounding range of the pixel position of the target point d10 is set in the present frame F11. After the search area SA has been set, evaluation values are calculated with each pixel in the search area SA being regarded as a reference point d11.

### 3. Example of Configuration According to First Embodiment

After the target and reference points have been set as illustrated in FIG. 5, data of the evaluation value table is generated by the configuration illustrated in FIG. 3.

In the configuration illustrated in FIG. 3, an image signal obtained at the input terminal 11 is supplied to a correlation operating unit 20 in the evaluation value table forming unit 12. The correlation operating unit 20 includes a reference point memory 21, a target point memory 22, and an absolute value calculating unit 23. In the image signal obtained at the input terminal 11, a pixel value of a frame used as a reference point is stored in the reference point memory 21. The signal of the frame stored in the reference point memory 21 is transferred to the target point memory 22 in the next frame period. In this example, the reference point is a signal in the preceding frame.

Then, the pixel value of the target point stored in the target point memory 22 and the pixel value of the reference point stored in the reference point memory 21 are supplied to the absolute value calculating unit 23, which detects an absolute value of the difference between the both pixel values. Here, the difference is a difference in luminance value between pixel signals. Data of the detected absolute value of the difference is supplied to a correlation determining unit 30. The correlation determining unit 30 includes a comparing unit 31, which compares the difference with a set threshold and obtains an evaluation value. The evaluation value is expressed as a binary, for example, the correlation is determined to be strong when the difference is equal to or smaller than the threshold, whereas the correlation is determined to be weak when the difference exceeds the threshold.

The evaluation value obtained in the correlation determining unit 30 is supplied to a pixel discriminating unit 40. The pixel discriminating unit 40 includes a gate unit 41 to discriminate the binary output from the correlation determining unit 30. Also, in order to control the gate unit 41, the pixel discriminating unit 40 includes a reference point pixel memory 42, a target point pixel memory 43, and a matching number count memory 44.

The reference point pixel memory 42 obtains, from the reference point memory 21, data of the pixel position of the reference point in a frame when the absolute value of the difference is determined to be equal to or smaller than the threshold in the comparison made by the comparing unit 31, and stores the obtained data. Accordingly, the reference point pixel memory 42 accumulates the value indicating the number of times the respective pixels in a frame are determined to be a reference point of a motion vector discriminated as a candidate.

The target point pixel memory 43 obtains, from the target point memory 22, data of the pixel position of the target point in a frame when the absolute value of the difference is determined to be equal to or smaller than the threshold in the comparison made by the comparing unit 31, and stores the obtained data. Accordingly, the target point pixel memory 43 accumulates the value indicating the number of times the respective pixels in a frame are determined to be a target point of a motion vector discriminated as a candidate.

In order to count the number of times each pixel is determined to be a reference point or a target point discriminated as a candidate, a determination of strong correlation made by the correlation determining unit 30 is output to the matching number count memory 44. Then, an output of the matching number count memory 44 is supplied to the reference point pixel memory 42 and the target point pixel memory 43, so that the memories 42 and 43 are allowed to count the number of times each pixel position is determined to be a reference point or a target point.

Then, passing of evaluation values in the gate unit 41 is controlled on the basis of the count number of discriminated pixels of respective pixels in a frame stored in the reference point pixel memory 42 and the count number of discriminated pixels of respective pixels in a frame stored in the target point pixel memory 43.

In the control performed here, it is determined whether the count number of discriminated pixels stored in the reference point pixel memory 42 exceeds a predetermined (or adaptively-set) threshold. When the count number exceeds the threshold, passing of the evaluation value about the pixel through the gate unit 41 is blocked.

Likewise, it is determined whether the count number of discriminated pixels stored in the target point pixel memory 43 exceeds a predetermined (or adaptively-set) threshold. When the count number exceeds the threshold, passing of the evaluation value about the pixel through the gate unit 41 is blocked.

Since the reference point and the target point are positioned on frames different by one frame period, the frame to control the gate unit 41 by an output of the reference point pixel memory 42 and the frame to control the gate unit 41 by an output of the target point pixel memory 43 have a difference of one frame.

The evaluation values passed through the gate unit 41 in the pixel discriminating unit 40 are supplied to an evaluation value table calculating unit 50 and are integrated in an evaluation value integrating unit 51 in the evaluation value table calculating unit 50, so that an integration result is stored in an evaluation value table memory 52. Data stored in the evaluation value table memory 52 obtained in this way is supplied as evaluation value table data from an output terminal 12a to a circuit in a subsequent stage.

### 4. Example of Process According to First Embodiment

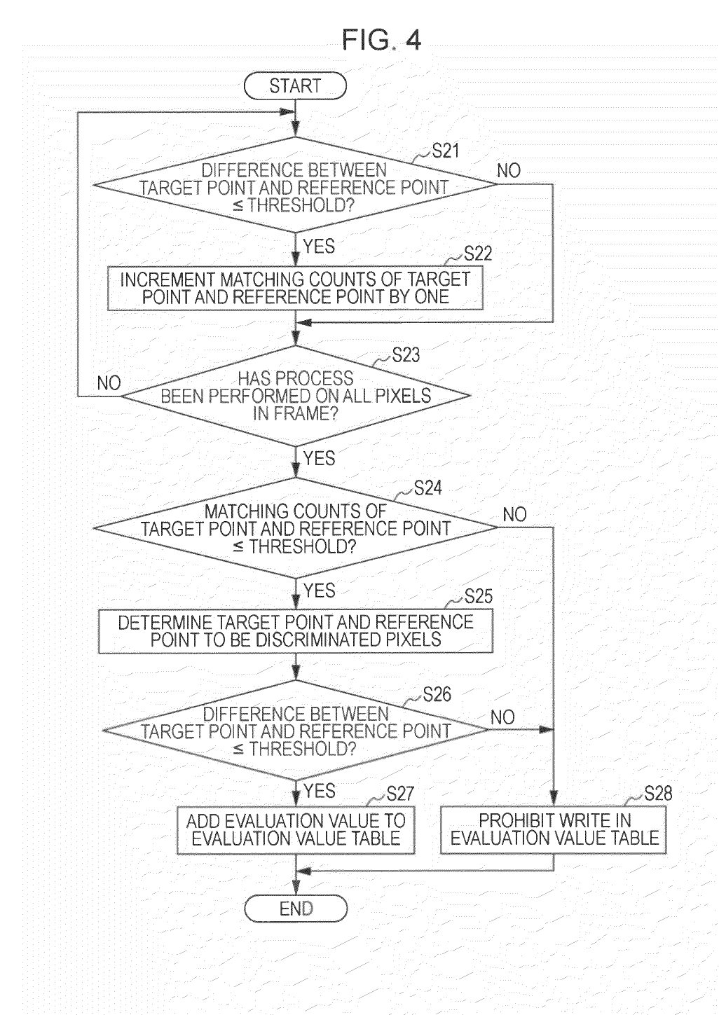

The flowchart in FIG. 4 illustrates a process performed by the configuration illustrated in FIG. 3.

Referring to FIG. 4, the configuration illustrated in FIG. 3 performs the process starting from determining discriminated pixels on the basis of the matching number of the target point and reference point till writing an evaluation value in the evaluation value table. Hereinafter, descriptions are given mainly about a process performed in the pixel discriminating unit 40 with reference to the flowchart. The flowchart in FIG. 4 illustrates a process to determine whether addition to the evaluation value table is to be performed, and does not necessarily correspond to the flow of the signal in the configuration illustrated in FIG. 3.

First, whether the difference between the target point and the reference point is equal to or smaller than the threshold is determined in comparison made by the comparing unit 31 (step S21). When the difference between the target point and the reference point is equal to or smaller than the threshold, the corresponding motion vector is a candidate motion vector.

If it is determined in step S21 that the difference is equal to or smaller than the threshold, the count value of the pixel position of the target point at the time is incremented by one, and also the count value of the pixel position of the reference point is incremented by one (step S22). The respective count values are matching count values and are stored in the reference point pixel memory 42 and the target point pixel memory 43, respectively.

After the count values are incremented in step S22 or after it is determined in step S21 that the difference value is larger than the threshold, it is determined whether the process has been performed on all the pixels used for motion detection in image data of a frame (step S23). If it is determined that the process has been performed on all the pixels in the frame, a pixel discriminating process is performed.

In the pixel discriminating process, the matching count value of a presently-determined pixel is compared with a preset threshold (or an adaptively-set threshold). Here, the respective pixels have a count value as a reference point and a count value as a target point. For example, it is determined whether each of the count value as a reference point and the count value as a target point is equal to or smaller than the threshold for discriminating a pixel (step S24).

If a positive determination is made in step S24, the target point and the reference point are determined to be discriminated pixels (step S25). After that, it is determined whether the difference between the target point and the reference point is equal to or smaller than the threshold (step S26). The threshold used in step S26 is the same as the threshold used in step S21.

If it is determined in step S26 that the difference is equal to or smaller than the threshold, the difference is allowed to pass through the gate unit 41, so that the corresponding evaluation value is added to the evaluation value table (step S27). If it is determined in step S24 that both the count values of the reference point and the target point exceed the threshold or if it is determined in step S26 that the difference between the target point and the reference point exceeds the threshold, writing the corresponding evaluation value in the evaluation value table is prohibited (step S28).

### 5. Principle of Process According to First Embodiment

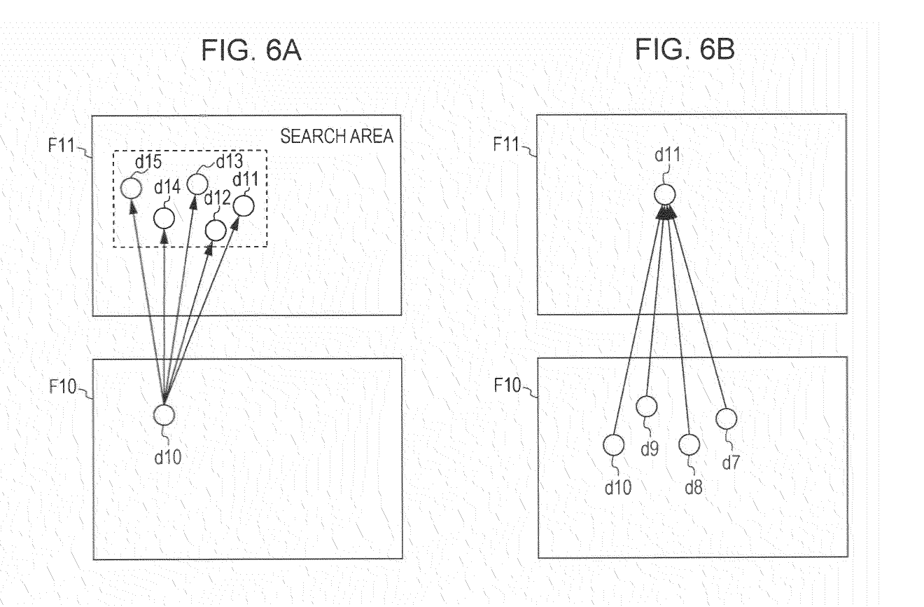

FIGS. 6A and 6B illustrate examples of counting the matching number. FIG. 6A illustrates an example of counting the matching number of the target point, whereas FIG. 6B illustrates an example of counting the matching number of the reference point.

Referring to FIG. 6A, a pixel d10 at a specific position in a preceding frame F10 is set as a target point. Assume that, viewed from the target point d10, five reference points d11 to d15 are detected as pixels having a luminance value within a predetermined range with respect to the luminance value of the target point d10 in a search area (indicated by a broken line) in a present frame F11. In this case, the count value of the matching number of the target point d10 is 5.

On the other hand, with reference to FIG. 6B, a pixel d11 at a specific position in the present frame F11 is set as a reference point. Assume that four target points d7 to d10 exist in the preceding frame F10 with respect to the reference point d11, as illustrated. In this case, the count value of matching number of the reference point d11 is 4.

In an actual image, only one reference point corresponds to the pixel at the target point d10 in the preceding frame F10. In the case where there are a plurality of reference points for one target point as illustrated in FIG. 6A and in the case where there are a plurality of target points for one reference point as illustrated in FIG. 6B, the candidate points except a true point are false candidates.

In the configuration illustrated in FIG. 3 and in the process illustrated in FIG. 4, the case where the matching number of the target point exceeds the threshold and the case where the matching number of the reference point exceeds the threshold are determined to be a state where many false candidates exist. The evaluation value in the state where many false candidates exist is not added to the evaluation value table, so that a correct motion vector can be detected.

Such a process of comparing the matching number with the threshold and restricting evaluation values is particularly effective when many pixels in the same state exist in the vicinity, e.g., in an image having a pattern of repeated stripes.

### 6. Example of Processing State According to First Embodiment

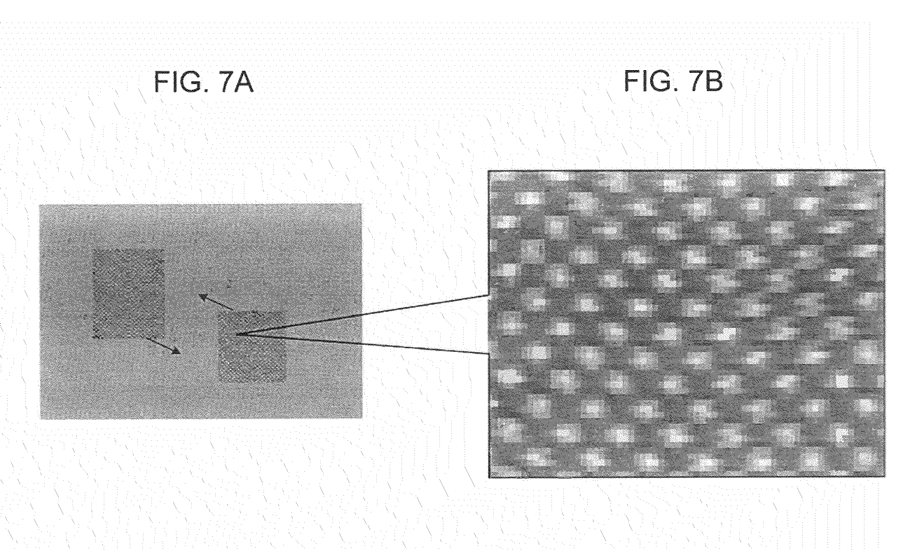

Now, an example of actually generating the evaluation value table in the configuration according to this embodiment is described with reference to FIGS. 7A, 7B, and so on.

FIGS. 7A and 7B illustrate an example of a test image used to generate an evaluation value table. FIG. 7A illustrates a frame of a test image. In the test image, two rectangular striped areas move in the directions indicated by arrows in accordance with change of frames. FIG. 7B is an enlarged view of the moving striped pattern, illustrating the state where the same shape is repeated.

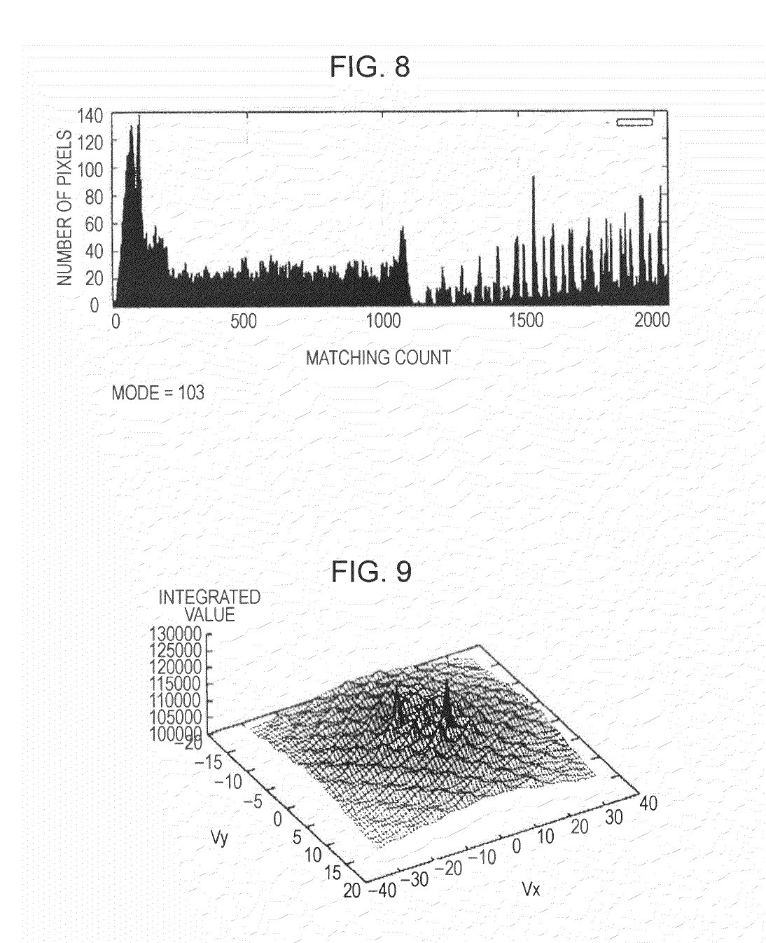

FIG. 8 illustrates a histogram of the matching number obtained by performing a determination of matching on the test image in the configuration illustrated in FIG. 3. In FIG. 8, the horizontal axis indicates a count value of the matching number, whereas the vertical axis indicates the number of pixels corresponding to the count value.

In the example illustrated in FIG. 8, a mode of the count value of the matching number is 103. That is, the pixels having a count value of 103 are most frequent in a frame.

FIG. 9 illustrates an integration state of evaluation values in the respective pixel positions in a frame in the case where the evaluation value table of the test image illustrated in FIG. 7 is generated by supplying an output of the correlation determining unit 30 illustrated in FIG. 3 to the evaluation value table calculating unit 50 without discrimination in the pixel discriminating unit 40. That is, the example illustrated in FIG. 9 corresponds to a characteristic graph according to the related art where pixel discrimination according to this embodiment is not performed.

In FIG. 9, Vx indicates the pixel position in the horizontal direction, Vy indicates the pixel position in the vertical direction, and the vertical axis indicates the integrated value. That is, FIG. 9 three-dimensionally illustrates an integration state of evaluation values in the respective pixels in a frame.

As can be understood from FIG. 9, in the image having a pattern where the same shape is repeated as illustrated in FIG. 7, many false evaluation values are integrated, which makes it very difficult to determine a correct evaluation value.

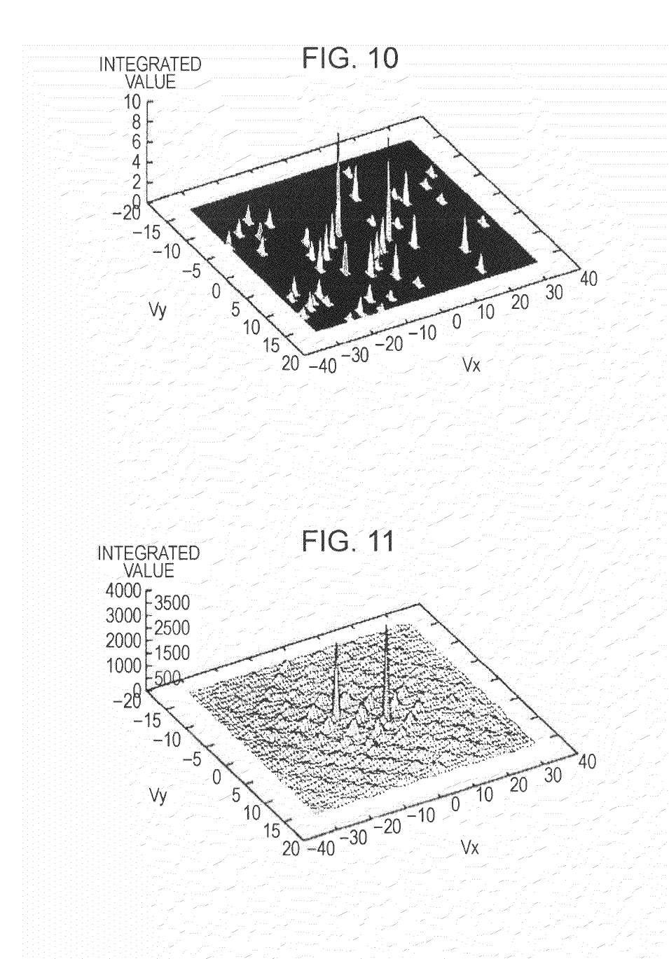

On the other hand, FIGS. 10 and 11 illustrate examples where pixel discrimination is performed on the basis of the matching number according to this embodiment.

In the example illustrated in FIG. 10, a count value of 20 is set as a threshold to determine the count value of the matching number, a value exceeding 20 is restricted, and evaluation values of the points (target points and reference points) having a count value of 20 or less are integrated.

As can be understood from FIG. 10, the restriction using the fixed count value of the matching number effectively eliminates false evaluation values, so that a motion vector can be eventually determined from the integrated evaluation value in a favorable manner.

In the example illustrated in FIG. 11, the mode 103 illustrated in FIG. 8 is set as the threshold to determine the count value of the matching number, a value exceeding 103 is restricted, and evaluation values of the points (target points and reference points) having a count value of 103 or less are integrated.

As can be understood from FIG. 11, the restriction using the mode of the count value significantly eliminates false evaluation values, so that a motion vector can be eventually determined from the integrated evaluation value in a favorable manner.

### 7. Modification of First Embodiment

The threshold to determine the count value of the matching number may be any of a fixed value and a mode. The value that should be selected varies depending on an image to be processed. When a fixed value is used, the fixed value may be set for each genre of image. For example, a plurality of types of fixed values may be prepared in accordance with the types of images: a fixed value for images of sport with relatively fast motions; and a fixed value for images of movie or drama with relatively slow motions. Then, an appropriate one of the fixed values may be selected and set.

In the case where a variable threshold such as a mode is set, the mode may be calculated for each frame. Alternatively, after a mode is once set, the threshold may be fixed to the set mode for a predetermined period (predetermined frame period). In that case, after the predetermined frame period has elapsed, a mode is calculated again and the threshold is set again. Alternatively, the mode may be calculated again and the threshold may be set again at the timing when the image significantly changes in the processed image signal, that is, when a so-called scene change is detected.

Alternatively, the threshold may be set under a condition other than the mode.

For example, an average or a weighted average of the count values of the matching number may be set as a threshold. More specifically, when the matching number is distributed in the range from 0 to 20 in a frame, the threshold is set to 10. When the matching number is distributed in the range from 0 to 2 in a frame, the threshold is set to 1. In this way, favorable evaluation values can be obtained even when an average is used as the threshold.

In the description given above, the count value of the matching number is determined in each of the target point and the reference point, whereby passing of evaluation values is restricted. Alternatively, the matching number may be counted in any one of the target point and the reference point, whereby passing of evaluation values may be restricted by determining whether the count value exceeds the threshold.

### 8. Example of Configuration According to Second Embodiment

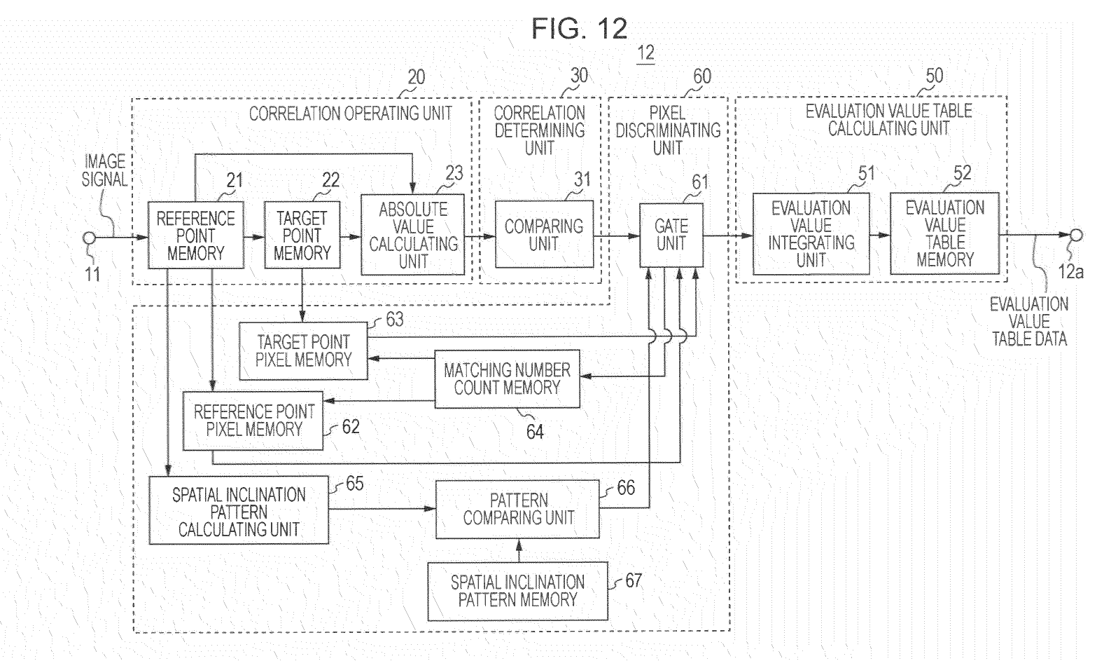

Next, a second embodiment of the present invention is described with reference to FIGS. 12 to 20.

In this embodiment, too, a motion vector detecting apparatus detects a motion vector from moving image data. The configuration of forming an evaluation value table on the basis of pixel value correlation information and determining a motion vector from data of the evaluation value table is the same as that according to the first embodiment described above.

The entire configuration and entire process of the motion vector detecting apparatus are the same as the configuration illustrated in FIG. 1 and the process illustrated in FIG. 2 according to the first embodiment. Also, the definition of a target pixel (target point) and a reference pixel (reference point) is the same as the definition according to the first embodiment.

In this embodiment, the evaluation value table forming unit 12 in the motion vector detecting apparatus illustrated in FIG. 1 has the configuration illustrated in FIG. 12. In the evaluation value table forming unit 12 illustrated in FIG. 12, the parts same as those in the evaluation value table forming unit 12 illustrated in FIG. 3 according to the first embodiment are denoted by the same reference numerals.

In the configuration according to this embodiment illustrated in FIG. 12, restriction by the matching number of the target point and the reference point is imposed, and also restriction is imposed in view of a factor about another target point or reference point in the evaluation value table forming process performed by the evaluation value table forming unit 12. Here, as the factor about another target point or reference point, evaluation values are integrated in the case where a spatial inclination between a pixel at the target point or a pixel at the reference point and a pixel adjacent thereto has a certain value or more on the basis of a predetermined condition. Otherwise, restriction is imposed. A specific example of the case where a spatial inclination has a certain value or more is described below. Here, a result of a determination made by using a spatial inclination pattern or a spatial inclination code is used.

In the configuration illustrated in FIG. 12, the correlation operating unit 20 and the correlation determining unit 30 have the same configuration as that illustrated in FIG. 3. That is, in the image signal obtained at the input terminal 11, a pixel value of a frame used as a reference point is stored in the reference point memory 21. The signal of the frame stored in the reference point memory 21 is transferred to the target point memory 22 in the next frame period.

Then, the pixel value of the target point stored in the target point memory 22 and the pixel value of the reference point stored in the reference point memory 21 are supplied to the absolute value calculating unit 23, which detects an absolute value of the difference between the both pixel values. Here, the difference is a difference in luminance value between pixel signals. Data of the detected absolute value of the difference is supplied to a correlation determining unit 30. The correlation determining unit 30 includes a comparing unit 31, which compares the difference with a set threshold and obtains an evaluation value. The evaluation value is expressed as a binary, for example, the correlation is determined to be strong when the difference is equal to or smaller than the threshold, whereas the correlation is determined to be weak when the difference exceeds the threshold.

The evaluation value obtained in the correlation determining unit 30 is supplied to a pixel discriminating unit 60. The pixel discriminating unit 60 includes a gate unit 61 to determine the binary output from the correlation determining unit 30. Also, in order to control the gate unit 61, the pixel discriminating unit 60 includes a reference point pixel memory 62, a target point pixel memory 63, and a matching number count memory 64. Furthermore, the pixel discriminating unit 60 includes a spatial inclination pattern calculating unit 65, a pattern comparing unit 66, and a spatial inclination pattern memory 67.

The process performed in the reference point pixel memory 62, the target point pixel memory 63, and the matching number count memory 64 in the pixel discriminating unit 60 is the same as the process performed in the respective memories 42, 43, and 44 in the pixel discriminating unit 40 illustrated in FIG. 3. That is, the reference point pixel memory 62 obtains, from the reference point memory 21, data of the pixel position of the reference point in a frame when the absolute value of the difference is determined to be equal to or smaller than the threshold in comparison made by the comparing unit 31, and stores the obtained data. Accordingly, the reference point pixel memory 62 accumulates the value indicating the number of times the respective pixels in a frame are determined to be a reference point of a motion vector discriminated as a candidate.

The target point pixel memory 63 obtains, from the target point memory 22, data of the pixel position of the target point in a frame when the absolute value of the difference is determined to be equal to or smaller than the threshold in the comparison made by the comparing unit 31, and stores the obtained data. Accordingly, the target point pixel memory 63 accumulates the value indicating the number of times the respective pixels in a frame are determined to be a target point of a motion vector discriminated as a candidate.

In order to count the number of times each pixel is determined to be a reference point or a target point discriminated as a candidate, a determination of strong correlation made by the correlation determining unit 30 is output to the matching number count memory 64. Then, an output of the matching number count memory 64 is supplied to the reference point pixel memory 62 and the target point pixel memory 63, so that the memories 62 and 63 are allowed to count the number of times each pixel position is determined to be a reference point or a target point.

Then, passing of evaluation values in the gate unit 61 is controlled on the basis of the count number of discriminated pixels of respective pixels in a frame stored in the reference point pixel memory 62 and the count number of discriminated pixels of respective pixels in a frame stored in the target point pixel memory 63.

The process of controlling passing of evaluation values in the gate unit 61 is the same as that according to the first embodiment so far.

In this embodiment, the pixel discriminating unit 60 includes the spatial inclination pattern calculating unit 65, the pattern comparing unit 66, and the spatial inclination pattern memory 67. With this configuration, pixels are further discriminated by using a spatial inclination pattern.

The spatial inclination pattern calculating unit 65 calculates a spatial inclination pattern of each pixel in a frame by calculating spatial inclinations between the pixel and eight pixels adjacent thereto. The calculated spatial inclination pattern is supplied to the pattern comparing unit 66, which compares the spatial inclination pattern with a spatial inclination pattern stored in the spatial inclination pattern memory 67 and determines the spatial inclination pattern. In accordance with the determined spatial inclination pattern, passing of evaluation values in the gate unit 61 is controlled.

Therefore, in the pixel discriminating unit 60 according to this embodiment, the gate unit 61 allows an evaluation value to pass therethrough only when the count value of the matching number is equal to or smaller than the threshold and when the spatial inclination pattern between the pixel and the adjacent pixels is in a predetermined state, and the evaluation value is integrated in the evaluation value table.

The evaluation values passed through the gate unit 61 in the pixel discriminating unit 60 are supplied to the evaluation value table calculating unit 50 and are integrated in the evaluation value integrating unit 51 in the evaluation value table calculating unit 50, so that an integration result is stored in the evaluation value table memory 52. Data stored in the evaluation value table memory 52 obtained in this way is supplied as evaluation value table data from the output terminal 12a to a circuit in a subsequent stage.

### 9. Example of Process According to Second Embodiment

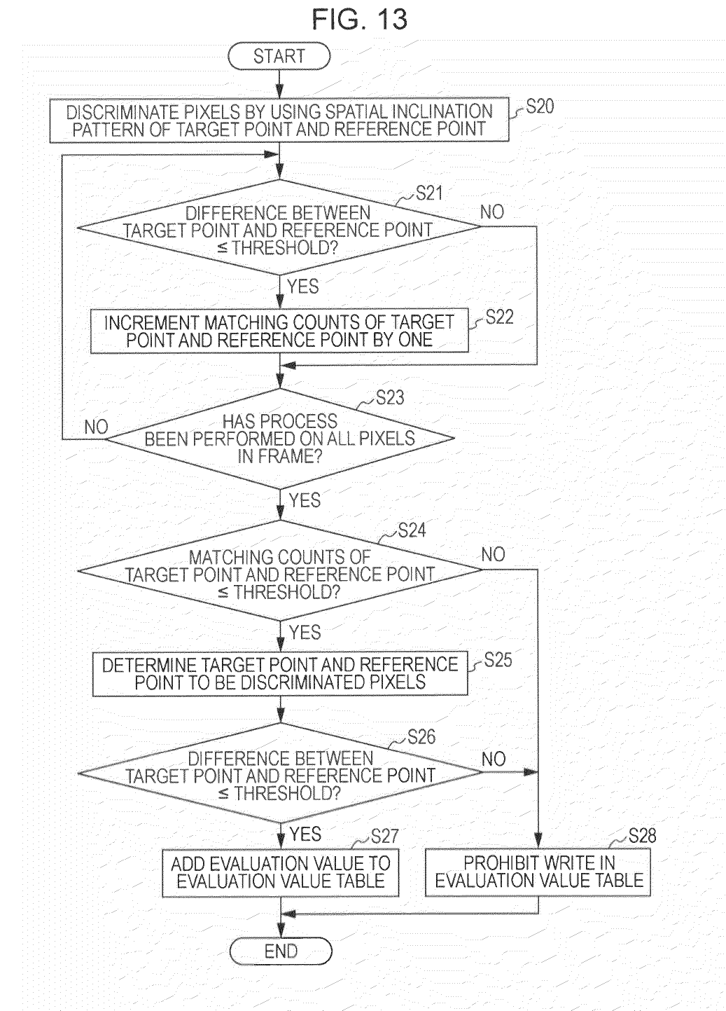

FIG. 13 is a flowchart illustrating a process performed in the configuration illustrated in FIG. 12.

In the flowchart in FIG. 13, the steps same as those in the flowchart in FIG. 4 are denoted by the same step numbers.

As the flowchart in FIG. 4, the flowchart in FIG. 13 illustrates a process to determine whether addition to the evaluation value table is to be performed, and does not necessarily correspond to the flow of the signal in the configuration illustrated in FIG. 12.

First, it is determined whether a spatial inclination pattern between the pixel of the evaluation value presently supplied to the gate unit 61 and the adjacent pixels is a specific pattern in both the reference point and target point, through a comparison made by the pattern comparing unit 66. If it is determined that the spatial inclination pattern is the specific pattern in both the reference point and target point, the evaluation value supplied to the gate unit 61 is allowed to pass therethrough. Otherwise, the evaluation value is not allowed to pass therethrough (step S20).

Thereafter, steps S21 to S28 are performed as in the flowchart in FIG. 4, so that control in the gate unit 61 is performed on the basis of the count value of the matching number together with the pixel discrimination in the pattern comparing unit 66.

That is, after the pixel discrimination based on the spatial inclination pattern, it is determined whether the difference between the target point and the reference point is equal to or smaller than the threshold through comparison in the comparing unit 31 (step S21).

If it is determined in step S21 that the difference is equal to or smaller than the threshold, the count values of the pixel positions of the target point and the reference point at the time are incremented by one (Step S22).

The comparison with the threshold in step S21 and the increment in step S22 are performed on all the pixels in a frame (step S23), and then a pixel discriminating process is performed.

In the pixel discriminating process, the count value of the matching number of the presently-determined pixel is compared with a preset threshold (or an adaptively-set threshold). For example, it is determined whether both the count values of the reference point and the target point are equal to or smaller than the threshold for discriminating a pixel (step S24).

If a positive determination is made in step S24, the target point and the reference point are determined to be discriminated pixels (step S25). After that, it is determined whether the difference between the target point and the reference point is equal to or smaller than the threshold (step S26).

If it is determined in step S26 that the difference is equal to or smaller than the threshold, the difference is allowed to pass through the gate unit 61, so that the corresponding evaluation value is added to the evaluation value table (step S27). If it is determined in step S24 that both the count values of the reference point and the target point exceed the threshold or if it is determined in step S26 that the difference between the target point and the reference point exceed the threshold, writing the corresponding evaluation value in the evaluation value table is prohibited (step S28).

### 10. Principle of Process According to Second Embodiment

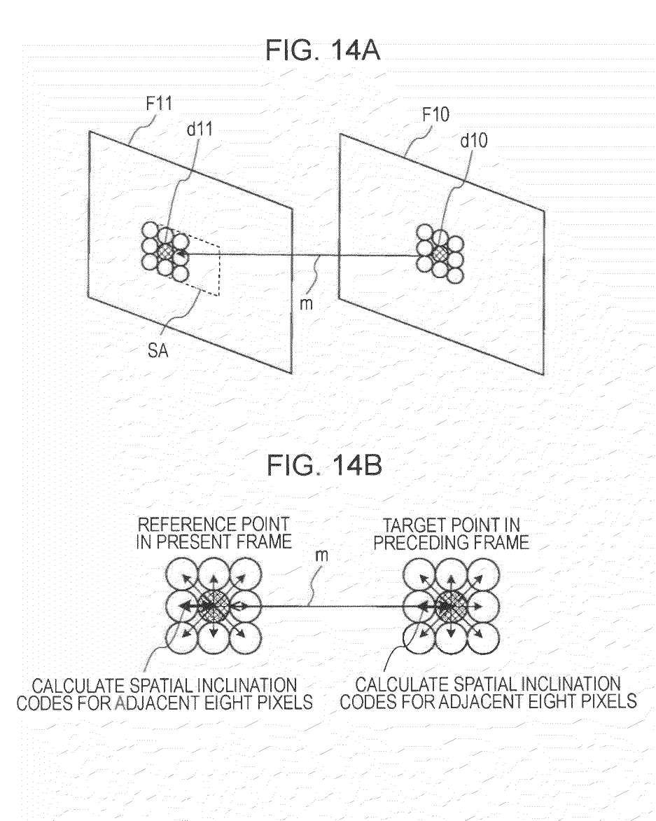

FIGS. 14A and 14B illustrate an overview of a processing state in the configuration illustrated in FIG. 12 and the flowchart illustrated in FIG. 13.

As illustrated in FIG. 14A, a pixel position serving as a basis to determine a motion vector in a preceding frame F10, which is image data of the preceding frame of the present frame F11, is set as a target point d10. After the target point d10 has been set, a search area SA in a predetermined range around the pixel position of the target point d10 is set in the present frame F11. After the search area SA has been set, evaluation values are calculated with respective pixels in the search area SA being a reference point d11.

In this example, as illustrated in FIG. 14B, spatial inclination codes in respective directions are calculated on the basis of differences between the target point and eight pixels adjacent thereto in the preceding frame F10. Also, spatial inclination codes in respective directions are calculated on the basis of differences between the reference point and eight pixels adjacent thereto in the present frame F11. Then, the case where the spatial inclination codes in the eight directions form a spatial inclination pattern in a preset specific spatial inclination code state is regarded as a discrimination condition. The discrimination condition using the spatial inclination pattern is added to the discrimination condition based on a comparison between the count value of the matching number and the threshold, whereby passing in the gate unit 61 is controlled.

In this case, as illustrated in FIGS. 14A and 14B, a motion direction “m” determined by a positional relationship between the target point and the reference point may be obtained and the motion direction may be used for determination. In this case, as illustrated in FIG. 14B, the spatial inclination code of the pixel adjacent to the target pixel in the motion direction “m” is determined, and also the spatial inclination code of the pixel adjacent to the reference pixel in the motion direction “m” is determined. The bold arrows illustrated in FIG. 14B indicate the directions of determining the spatial inclination codes. If the respective spatial inclination codes match, the evaluation value is allowed to pass through the gate unit 61.

The discrimination based on a determination of special inclination codes using the motion direction and the discrimination based on a comparison between the count value of the matching number and the threshold may be performed in the gate unit 61. Alternatively, the discrimination based on a comparison of spatial inclination patterns, the discrimination based on a determination of spatial inclination codes using a motion direction, and the discrimination based on a comparison between the count value of the matching number and the threshold may be performed in combination.

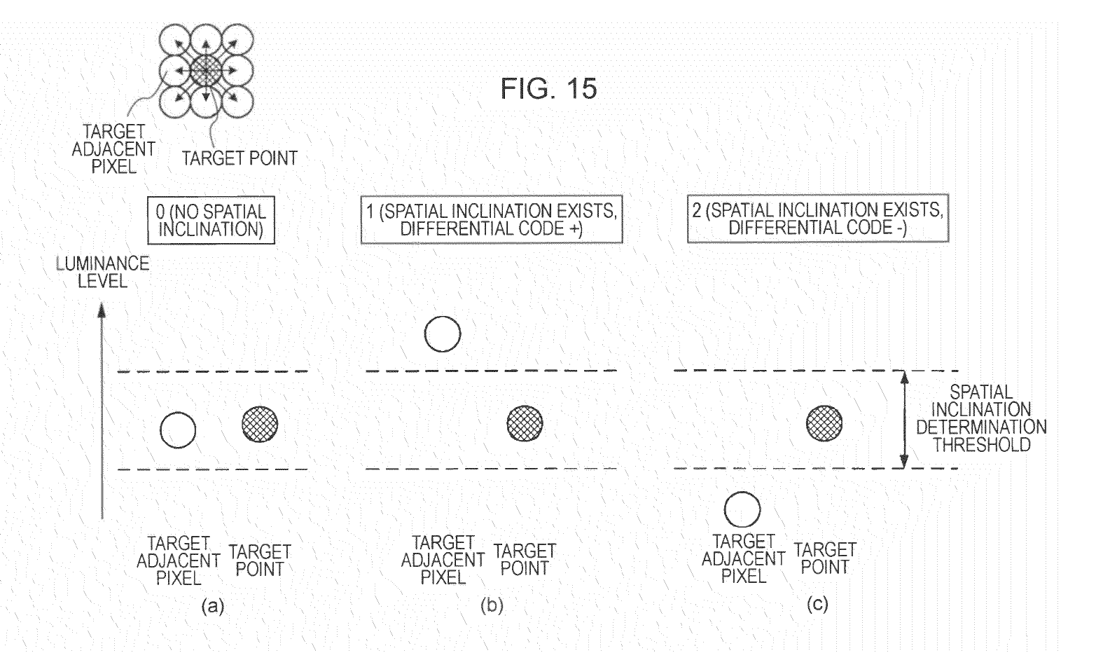

FIG. 15 illustrates examples of determining a spatial inclination code with respect to an adjacent pixel on the basis of a target point and a reference point.

As illustrated in the upper left of FIG. 15, eight pixels adjacent to the pixel at a target point are regarded as adjacent pixels. The pixel value of the target point is compared with the pixel value of each of the adjacent pixels, and it is determined whether the difference in pixel value (luminance value) is within a certain range on the basis of the target point, whether the difference is beyond the certain range in a plus direction, or whether the difference is beyond the certain range in a minus direction.

In FIG. 15, part (a) illustrates the case where the difference in pixel value between the target point and the adjacent pixel is within the certain range. In this case, there is no spatial inclination between the target point and the adjacent pixel, so that the spatial inclination is zero. The spatial inclination at zero is a state where there exists substantially no spatial inclination between the target point and the adjacent pixel. When the certain range used to determine the difference illustrated in FIG. 15 is narrow, the range of allowable difference values corresponding to no spatial inclination is narrow. When the certain range is wide, the range of allowable difference values corresponding to no spatial inclination is wide.

In FIG. 15, part (b) illustrates the case where the difference is beyond the certain range in the plus direction because the value of the adjacent pixel is larger than that of the target point. In this case, there exists a spatial inclination between the target point and the adjacent pixel, so that a difference code is “+”.

In FIG. 15, part (c) illustrates the case where the difference is beyond the certain range in the minus direction because the value of the adjacent pixel is smaller than that of the target point. In this case, there exists a spatial inclination between the target point and the adjacent pixel, so that a difference code is “−”.

The process of determining a spatial inclination code of the target point has been described with reference to FIG. 15. This process can be applied also to the reference point. In the case of the reference point, the pixel value of the reference point is used as a basis, and the adjacent pixel is a pixel adjacent to the reference point.

In this way, the codes of spatial inclinations with respect to the eight adjacent pixels are determined, and a spatial inclination pattern of a pixel at a basis position (target pixel or reference pixel) is calculated on the basis of the codes of the eight adjacent pixels.

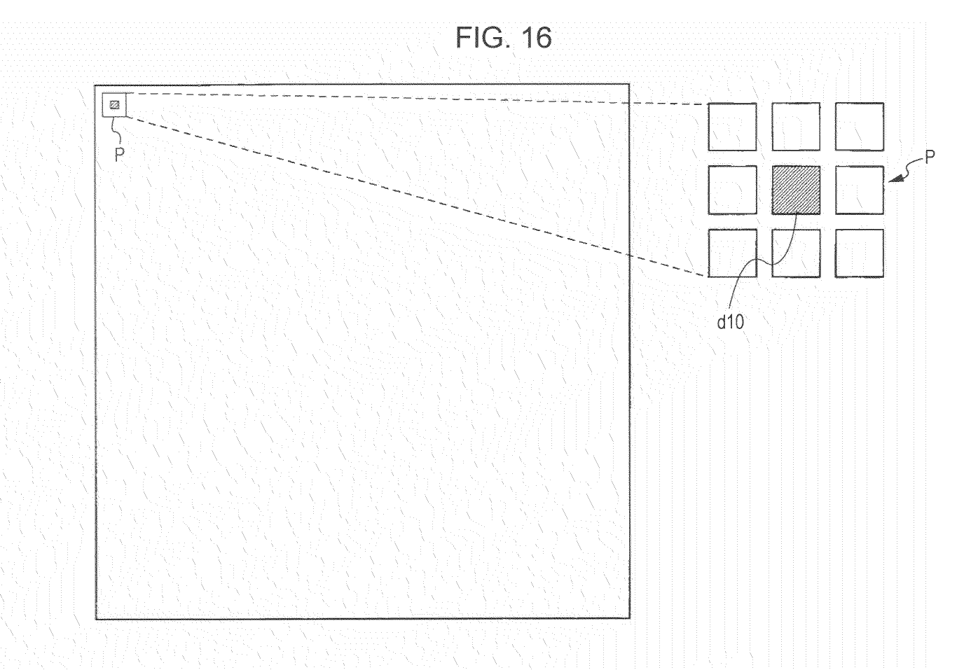

Here, as illustrated in FIG. 16, assume a spatial inclination pattern P composed of a target point (or reference point) and eight surrounding pixels, nine pixels in total. In the spatial inclination pattern P, the spatial inclinations between the target point d10 and the eight surrounding pixels have the same code. Such a spatial inclination pattern corresponds to the state where the luminance at the target point (or reference point) is completely different from that of the surrounding pixels.

When both the target point and reference point have the spatial inclination pattern illustrated in FIG. 16, control is performed to allow the evaluation value of the target point and reference point positioned at the center of the pattern to pass through the gate unit 61. Note that the spatial inclination pattern illustrated in FIG. 16 is an example, and another spatial inclination pattern may be determined.

In this embodiment, the principle of the process of controlling passing of an evaluation value through the gate unit 61 on the basis of the count value of the matching number is the same as the principle described above in the first embodiment with reference to FIGS. 6A and 6B.

As described above, by performing the discrimination of evaluation values on the basis of a spatial inclination pattern and the discrimination by comparison between the count value of the matching number and the threshold, candidate evaluation values can be narrowed down, so that a favorable evaluation value table can be obtained.

### 11. Example of Processing State According to Second Embodiment

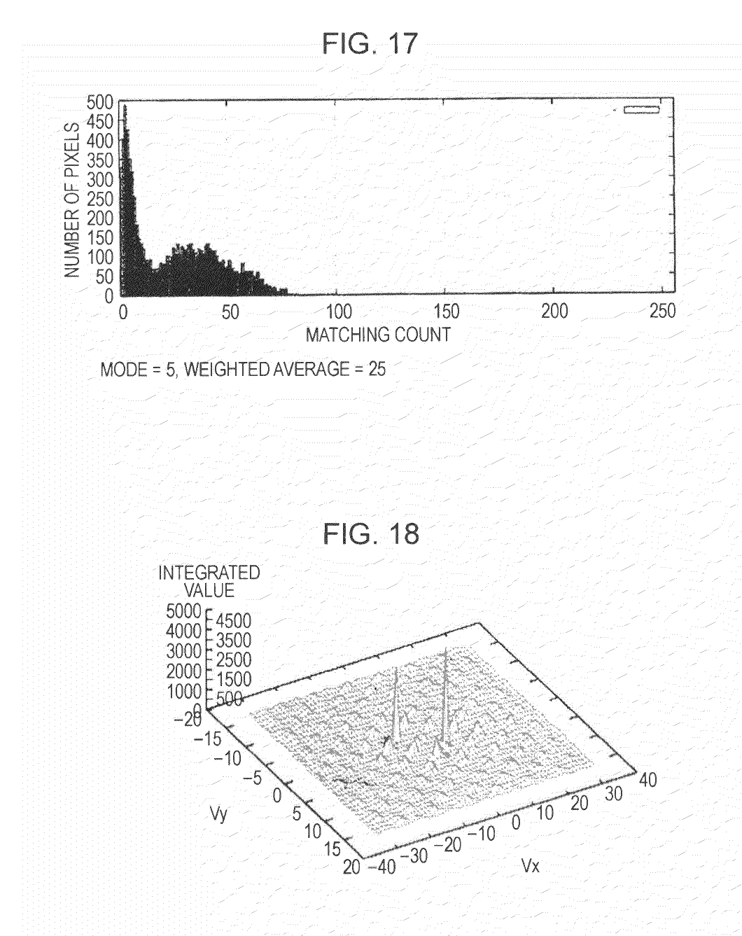

With reference to FIGS. 17 to 20, descriptions are given about an example of obtaining an evaluation value table for the test image illustrated in FIGS. 7A and 7B by performing the process of this embodiment.

FIG. 17 illustrates a histogram of the matching number obtained through a determination of matching made on the evaluation values discriminated by the spatial inclination pattern illustrated in FIG. 16 in the configuration illustrated in FIG. 12 in the test image illustrated in FIGS. 7A and 7B. In FIG. 17, the horizontal axis indicates the count value of the matching number, whereas the vertical axis indicates the number of pixels corresponding to the count value.

In the example illustrated in FIG. 17, the mode of the count value of the matching number is 5, and the weighted average is 25. That is, the pixels having a count value of 5 is the most frequent in a frame, and the weighted average is 25. As can be understood from a comparison with the histogram illustrated in FIG. 8, the evaluation values are limited in a narrow range in the histogram illustrated in FIG. 17.

FIG. 18 illustrates, as a reference, an example of an integration state of evaluation values in the case where the gate unit 61 in the pixel discriminating unit 60 performs only discrimination of output from the correlation determining unit 30 illustrated in FIG. 12, that is, discrimination of evaluation values by a spatial inclination pattern.

In FIG. 18, Vx indicates the pixel position in the horizontal direction, Vy indicates the pixel position in the vertical direction, and the vertical axis indicates the integrated value. That is, FIG. 18 three-dimensionally illustrates an integration state of evaluation values in the respective pixels in a frame.

As can be understood from FIG. 18, the discrimination using the spatial inclination pattern narrows down evaluation values, compared to the state illustrated in FIG. 9 where no discrimination is performed. Note that, as can be understood from the values on the vertical axis in FIG. 18, the integrated value of the evaluation values at the peak is considerably high, and the evaluation values are not sufficiently narrowed down.

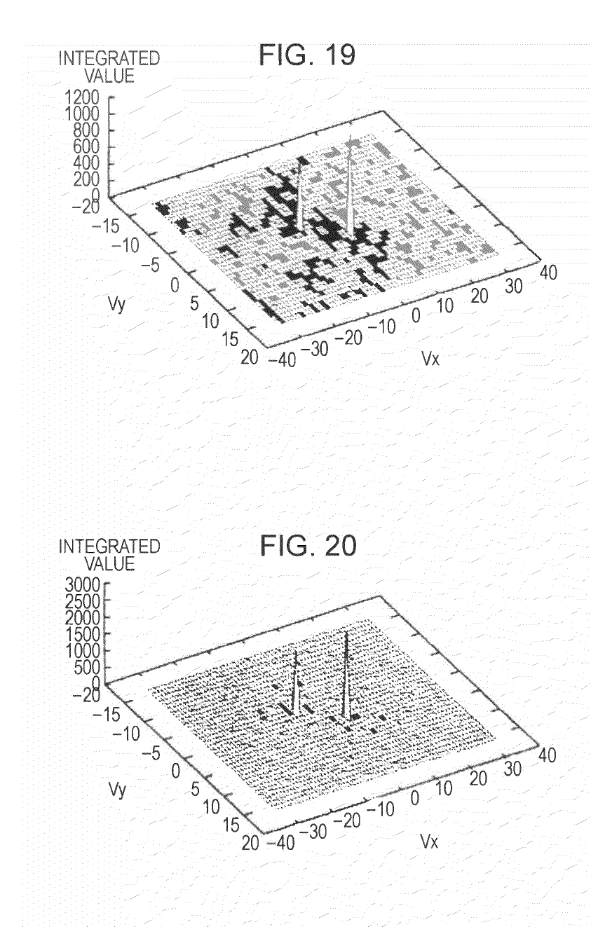

On the other hand, FIGS. 19 and 20 illustrate an example of the case where discrimination of pixels is performed by using the matching number of this embodiment in the test image illustrated in FIGS. 7A and 7B.

In the example illustrated in FIG. 19, discrimination using the spatial inclination patter is performed, a count value of 5, which is the mode, is set as a threshold to determine the count value of the matching number, a value exceeding 5 is restricted, and evaluation values at the points (target point and reference point) having a count value of 5 or less are integrated.

As can be understood from FIG. 19, restriction by fixing the count value of the matching number significantly eliminates false evaluation values, so that an eventual determination of a motion vector can be favorably performed on the basis of the integrated value of the evaluation values.

In the example illustrated in FIG. 20, discrimination using the spatial inclination pattern is performed, a count value of 25, which is the weighted average illustrated in FIG. 17, is set as a threshold to determine the count value of the matching number, a value exceeding 25 is restricted, and evaluation values at the points (target point and reference point) having a count value of 25 or less are integrated.

As can be understood from FIG. 20, restriction by setting the count value of the matching number as a mode significantly eliminates false evaluation values, so that an eventual determination of a motion vector can be favorably performed on the basis of the integrated value of the evaluation values.

### 12. Modification of Second Embodiment

In the second embodiment, no description is given about an example of fixing the threshold to determine the count value of the matching number. However, as in the first embodiment, a threshold fixed in advance may be constantly used. The respective examples described above in the first embodiment can be applied to the timing to change the threshold that is variable like the mode. Also, the threshold can be set on the basis of a condition except the mode, e.g., an average, as in the first embodiment.

In the configuration according to the second embodiment, too, the count value of the matching number is determined at each of the target point and the reference point to restrict passing of evaluation values. Alternatively, the matching number of evaluation values may be counted in any one of the target point and the reference point, and passing of evaluation values may be restricted by determining whether the count value exceeds the threshold.

Furthermore, in the second embodiment, the spatial inclination pattern or a comparison of spatial inclination codes is applied as a process of restricting integration to the evaluation value table in a factor other than the count value of the matching number. Alternatively, another process may be combined. Furthermore, regarding the spatial inclination pattern, matching with a spatial inclination pattern other than the pattern illustrated in FIG. 16 may be determined.

### 13. Example of Configuration According to Third Embodiment

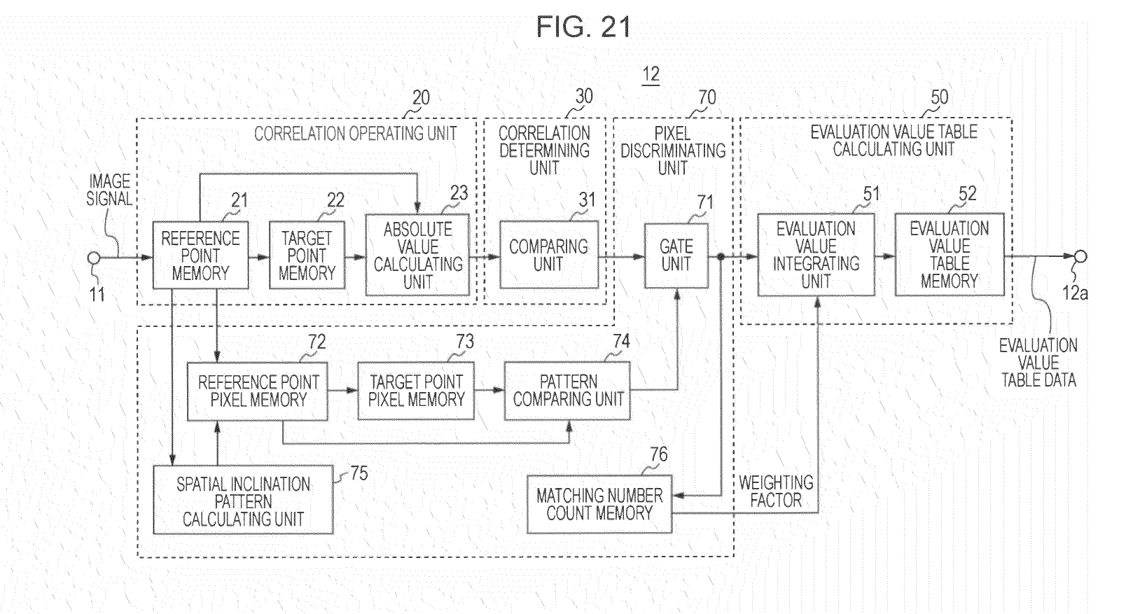

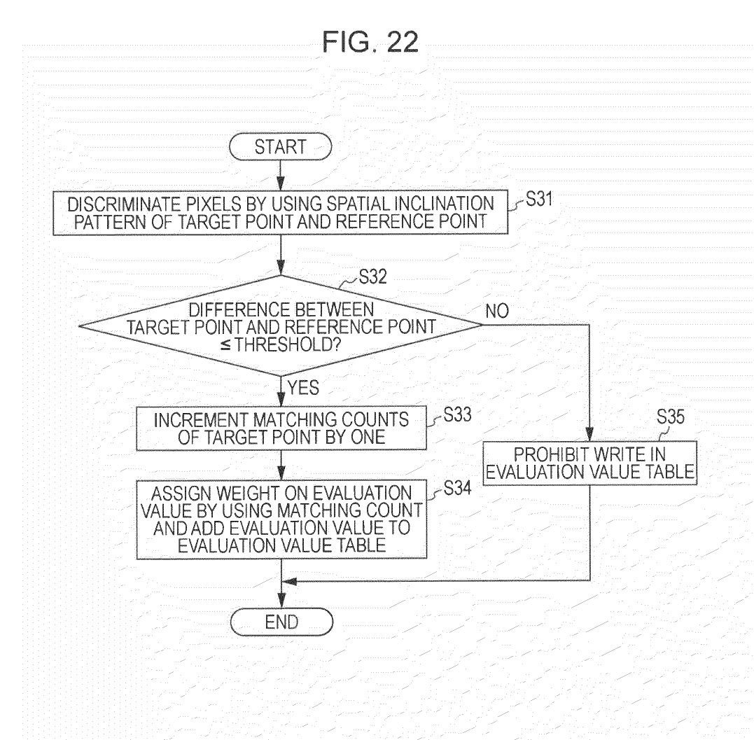

Hereinafter, a third embodiment of the present invention is described with reference to FIGS. 21 and 22.

In this embodiment, too, a motion vector detecting apparatus detects a motion vector from moving image data. The characteristic that an evaluation value table is formed on the basis of pixel value correlation information and that a motion vector is determined on the basis of data of the evaluation value table is the same as that in the first embodiment.

The entire configuration and the entire process of the motion vector detecting apparatus are the same as the configuration illustrated in FIG. 1 and the flowchart illustrated in FIG. 2 according to the first embodiment. Also, the definition of a target pixel (target point) and a reference pixel (reference point) is the same as that in the first embodiment.

In this embodiment, the evaluation value table forming unit 12 in the motion vector detecting apparatus illustrated in FIG. 1 has the configuration illustrated in FIG. 21. In the evaluation value table forming unit 12 illustrated in FIG. 21, the parts same as those in the evaluation value table forming unit 12 illustrated in FIG. 3 according to the first embodiment are denoted by the same reference numerals.

In the configuration according to this embodiment illustrated in FIG. 21, the evaluation value table is weighted by using the matching number of the target point and the reference point in the evaluation value table forming process performed by the evaluation value table forming unit 12. That is, integration of evaluation values is restricted by using the matching number in the first embodiment, whereas in the third embodiment, weighting to evaluate the reliability of evaluation values in the evaluation value table in a plurality of stages is performed in accordance with the matching number.

In the configuration illustrated in FIG. 21, the correlation operating unit 20 and the correlation determining unit 30 have the same configuration as that illustrated in FIG. 3. That is, in the image signal obtained at the input terminal 11, a pixel value of a frame used as a reference point is stored in the reference point memory 21. The signal of the frame stored in the reference point memory 21 is transferred to the target point memory 22 in the next frame period.

Then, the pixel value of the target point stored in the target point memory 22 and the pixel value of the reference point stored in the reference point memory 21 are supplied to the absolute value calculating unit 23, which detects an absolute value of the difference between the both pixel values. Here, the difference is a difference in luminance value of pixel signals. Data of the detected absolute value of the difference is supplied to the correlation determining unit 30. The correlation determining unit 30 includes the comparing unit 31, which compares the difference with a set threshold and obtains an evaluation value. The evaluation value is expressed as a binary, for example, the correlation is determined to be strong when the difference is equal to or smaller than the threshold, whereas the correlation is determined to be weak when the difference exceeds the threshold.

The evaluation value obtained in the correlation determining unit 30 is supplied to a pixel discriminating unit 70. The pixel discriminating unit 70 includes a gate unit 71 to determine the binary output from the correlation determining unit 30. Also, in order to control the gate unit 71, the pixel discriminating unit 70 includes a reference point pixel memory 72, a target point pixel memory 73, a pattern comparing unit 74, and a spatial inclination pattern memory 75. Furthermore, the pixel discriminating unit 70 includes a matching number count memory 76.

The process performed in the reference point pixel memory 72, the target point pixel memory 73, and the matching number count memory 76 in the pixel discriminating unit 70 is the same as the process performed in the respective memories 42, 43, and 44 in the pixel discriminating unit 40 illustrated in FIG. 3. That is, the reference point pixel memory 72 obtains, from the reference point memory 21, data of the pixel position of the reference point in a frame when the absolute value of the difference is determined to be equal to or lower than the threshold by the comparing unit 31, and stores the obtained data. Accordingly, the reference point pixel memory 72 accumulates the value indicating the number of times the respective pixels in a frame are determined to be a reference point of a motion vector discriminated as a candidate.

The target point pixel memory 73 obtains, from the target point memory 22, data of the pixel position of the target point in a frame when the absolute value of the difference is determined to be equal to or smaller than the threshold through comparison by the comparing unit 31, and stores the obtained data. Accordingly, the target point pixel memory 73 accumulates the value indicating the number of times the respective pixels in a frame are determined to be a target point of a motion vector discriminated as a candidate.

In order to count the number of times each pixel is determined to be a reference point or a target point discriminated as a candidate, a determination of strong correlation made by the correlation determining unit 30 is output to the matching number count memory 76. The matching number count memory 76 outputs a weighting factor according to the count value of the matching number at each pixel position.

When the spatial inclination pattern calculating unit 75 determines that there exists a spatial inclination, the pattern comparing unit 74 compares the spatial inclination patterns at the target point and the reference point, and determines whether the patterns match. The spatial inclination pattern calculating unit 75 determines the presence/absence of a spatial inclination pattern by calculating spatial inclinations between each pixel in a frame and eight surrounding pixels adjacent to the pixel.

If it is determined that there exists a spatial inclination and that the spatial inclination pattern matches, the evaluation value output at the time by the correlation determining unit 30 is allowed to pass through the gate unit 71. If the spatial inclination pattern does not match, the evaluation value output at the time by the correlation determining unit 30 is not allowed to pass through the gate unit 71.

The evaluation value passed through the gate unit 71 is supplied to the evaluation value table calculating unit 50 and is integrated to data of the evaluation value table in the evaluation value table memory 52 by the evaluation value integrating unit 51.

Here, a weighting factor output from the matching number count memory 76 in the pixel discriminating unit 70 is supplied to the evaluation value integrating unit 51, and the integrated value of the evaluation values at the respective pixel positions is multiplied by the weighting factor. An example of the weighting factor is described below. For example, when the matching number is 1, the factor is 1, and the factor decreases from 1 as the matching number increases from 1.

The evaluation values multiplied by the factor according to the matching number are integrated by the evaluation value integrating unit 51 in the evaluation value table calculating unit 50, and an integration result is stored in the evaluation value table memory 52. Then, the data stored in the evaluation value table memory 52 obtained in the above-described manner is supplied as evaluation value table data from the output terminal 12a to a circuit in the subsequent stage.

### 14. Example of Process According to Third Embodiment

FIG. 22 is a flowchart illustrating a process performed by the configuration illustrated in FIG. 21.

Like the flowchart in FIG. 4, the flowchart in FIG. 22 illustrates a process to determine whether addition to the evaluation value table is to be performed, and does not necessarily correspond to the flow of the signal in the configuration illustrated in FIG. 21.

First, it is determined whether the spatial inclination patterns of the reference point and the target point of the pixel corresponding to the evaluation value presently supplied to the gate unit 71 match each other. If it is determined that the reference point and the target point have a same specific pattern, the evaluation value supplied to the gate unit 71 is allowed to pass therethrough. If the patterns do not match, the evaluation value is not allowed to pass therethrough (step S31). In step S31, pixel discrimination is performed by using a spatial inclination pattern.

Then, it is determined whether the difference between the reference point and the target point is equal to or smaller than the threshold (step S32). This determination is made by the correlation determining unit 30. If the difference is larger than the threshold, the evaluation value of the corresponding pixel is not allowed to pass and is not integrated to the evaluation value table stored in the evaluation value table memory 52 (step S35).

On the other hand, if it is determined in step S32 that the difference between the reference point and the target point is equal to or smaller than the threshold, the matching number at the target point is counted and a count result is stored in the matching number count memory 76 (step S33). Then, a factor based on the stored count value is output from the matching number count memory 76.

Then, the evaluation value to be integrated in the evaluation value table about the target point determined in step S32 is multiplied by a weighting factor with the use of the matching number stored in the matching number count memory 76, and a multiplication result is stored in the evaluation value table memory 52 (step S34).

When the matching number is 1 with respect to a certain target point, which is an ideal state, the weighting factor multiplied in step S34 is 1, and the evaluation value 1 at the target point is integrated in the evaluation value table. When the weighting factor is 1, addition reliability is 1. When the matching number is 2 or more, the weighting factor is decreased to less than 1 according to the value. For example, when the matching number is 10, addition reliability is 1/10 and the weighting factor is also 1/10, and the evaluation value 0.1 at the target point is integrated in the evaluation value table.

As described above, the respective evaluation values in the evaluation value table are weighted with a matching number in this embodiment. Accordingly, the evaluation values are proportional to a matching number, so that favorable evaluation values can be obtained.

### 15. Example of Configuration and Operation of Motion Vector Extracting Unit

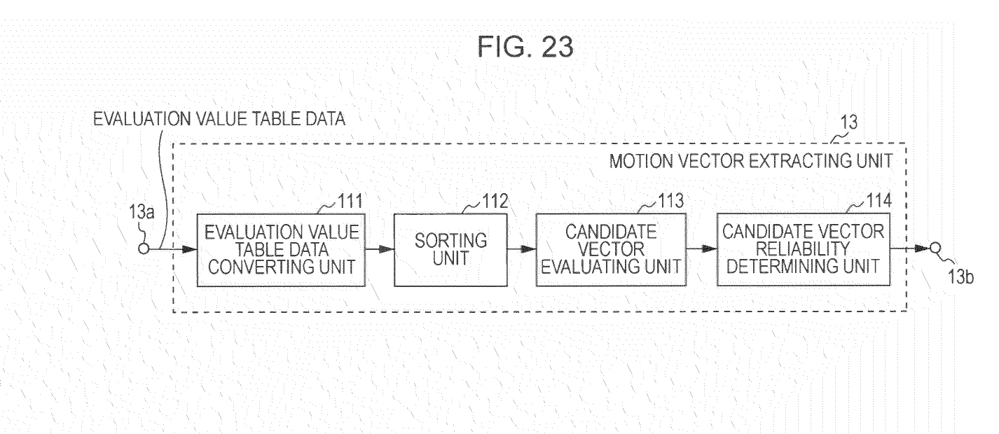

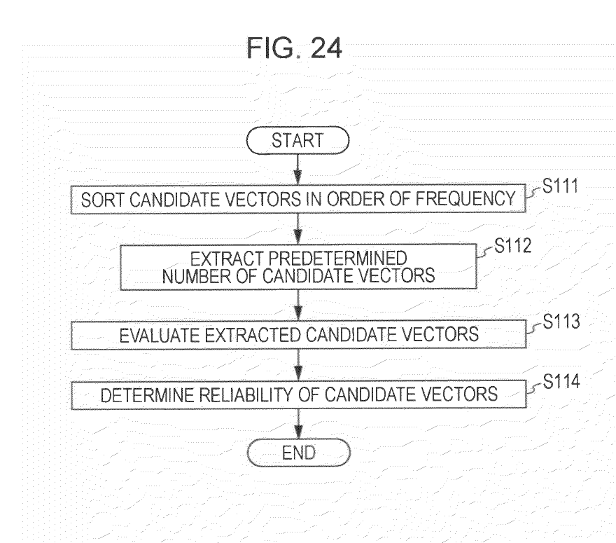

Next, with reference to FIGS. 23 and 24, descriptions are given about an example of the configuration and operation of the motion vector extracting unit 13 in the motion vector detecting apparatus illustrated in FIG. 1.

FIG. 23 illustrates an example of the configuration of the motion vector extracting unit 13 illustrated in FIG. 1.

In the motion vector extracting unit 13, evaluation value table data is supplied to an input terminal 13a. The evaluation value table data is data of the evaluation value table of motion vectors, obtained in the configuration according to any of the first to third embodiments described above, and is data of integrated motion vectors that can be candidate vectors in a frame.

For example, the evaluation value table data is supplied from the evaluation value table memory 52 in the evaluation value table calculating unit 50 illustrated in FIG. 3 and is supplied to an evaluation value table data converting unit 111.

The evaluation value table data converting unit 111 converts the evaluation value table data supplied thereto to data of frequency values or differential values. Then, a sorting unit 112 sorts candidate vectors in a frame in the converted data in order of frequency. The evaluation value table data of the candidate vectors sorted in order of frequency is supplied to a candidate vector evaluating unit 113. Here, predetermined upper-ranked candidate vectors among the sorted candidate vectors are supplied to the candidate vector evaluating unit 113. For example, among high-frequency candidate vectors existing in a frame, ten highest-frequency candidate vectors are extracted and are supplied to the candidate vector evaluating unit 113.

The candidate vector evaluating unit 113 evaluates each of the highest-frequency candidate vectors supplied thereto under a predetermined condition. Here, the evaluation is performed under the predetermined condition, e.g., even if a candidate vector is within a predetermined upper rank in the frequency value, the candidate vector is eliminated if the frequency value thereof is equal to or smaller than a predetermined threshold.

Alternatively, the reliability of the candidate vectors may be evaluated by using the data used for discrimination of pixels in the evaluation value table forming unit 12 (FIG. 1) in the preceding stage of the motion vector extracting unit 13. In the case where the reliability of the candidate vectors is evaluated by using the data used for discrimination of pixels, data of the discriminated target point that is used for discrimination of pixels by the pixel discriminating unit 40 illustrated in FIG. 3 is used. The data of the discriminated target point is obtained from the evaluation value table forming unit 12, a most appropriate candidate vector viewed from respective discriminated target points is determined, and the candidate vectors are evaluated.

On the basis of the evaluation result of the respective candidate vectors obtained in the candidate vector evaluating unit 113, the candidate vector reliability determining unit 114 determines a highly-reliable candidate vector among the candidate vectors, and outputs data of the highly-reliable candidate vector from an output terminal 13b.

The reliability data of the candidate vector output from the output terminal 13b is supplied to the motion vector determining unit 14 illustrated in FIG. 1.

FIG. 24 is a flowchart illustrating an example of a process to extract candidate vectors from the evaluation value table data by the motion vector extracting unit 13 illustrated in FIG. 23.

First, the candidate vectors indicated by the evaluation value table data are sorted in order of frequency (step S111). Among the sorted candidate vectors, a predetermined number of candidate vectors are extracted in descending order of frequency. For example, ten candidate vectors may be extracted in descending order of frequency (step S112).

Then, the extracted candidate vectors are evaluated to determine whether each of the candidate vectors is appropriate, so that the candidate vectors are narrowed down (step S113). For example, the frequency value of the respective candidate vectors is determined. When a candidate vector has a frequency value equal to or smaller than the threshold, the evaluation value of the candidate vector is small. Various processes may be adopted as a process of evaluating candidate vectors, and the evaluating process has an influence on the accuracy of extracting candidate vectors.

On the basis of a result of the evaluating process, the reliability of each candidate vector is determined. Then, only highly-reliable candidate vectors, that is, the candidate vectors that are likely to be assigned to an image, are supplied to the motion vector determining unit 14 illustrated in FIG. 1 (step S114).

### 16. Example of Configuration and Operation of Motion Vector Determining Unit

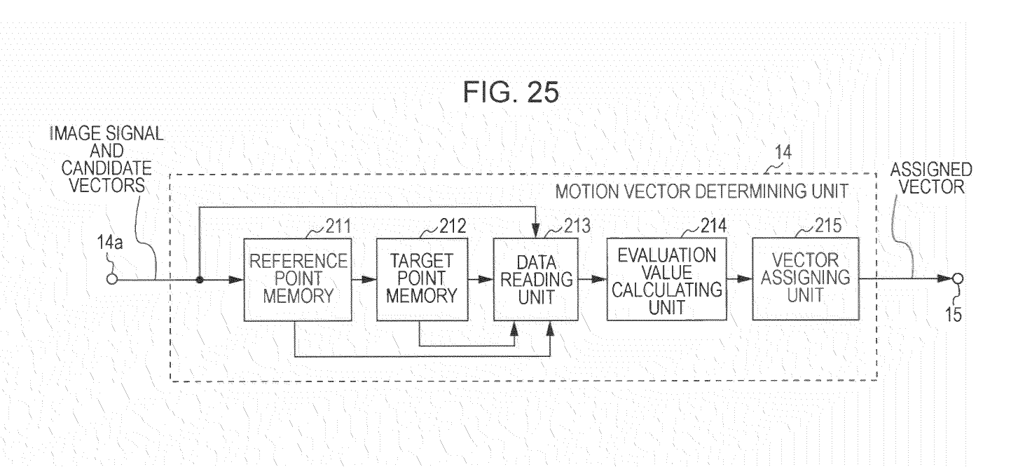

With reference to FIGS. 25 to 27, descriptions are given about an example of the configuration and operation of the motion vector determining unit 14 in the motion vector detecting apparatus illustrated in FIG. 1.

FIG. 25 illustrates an example of the configuration of the motion vector determining unit 14 illustrated in FIG. 1. The motion vector determining unit 14 performs a process of assigning any of a plurality of candidate vectors supplied from the motion vector extracting unit 13 to each pixel in a frame.

In this example, a fixed block, which is composed of a predetermined number of pixels, is set around each pixel position as a target point, whereby a motion vector is determined.

With reference to FIG. 25, data of candidate motion vectors and an image signal of the candidate vectors are supplied to an input terminal 14a of the motion vector determining unit 14. The image signal is supplied to a reference point memory 211 as a frame memory, where the image signal of one frame is stored. Then, the image signal stored in the reference point memory 211 is transferred to a target point memory 212 every frame period. Thus, the image signal stored in the reference point memory 211 and the image signal stored in the target point memory 212 constantly have a lag of one frame.

Then, a pixel signal of a fixed block having a predetermined size including a target point at the center is read from the image signal stored in the target point memory 212 to a data reading unit 213. Likewise, a pixel signal of a fixed block having a predetermined size including a reference point at the center is read from the image signal stored in the reference point memory 211 to the data reading unit 213. The pixel positions of the target point and the reference point (target pixel and reference pixel) read by the data reading unit 213 are determined by the data reading unit 213 on the basis of the data of the candidate vectors supplied from the motion vector extracting unit 13 (FIG. 1). For example, when there are ten candidate vectors, ten reference points indicated by the ten candidate vectors extending from the target point are determined.

Then, the pixel signal of the fixed area including the target point at the center and the pixel signal of the fixed area including the reference point at the center read by the data reading unit 213 are supplied to an evaluation value calculating unit 214, where the difference between the pixel signals in the both fixed areas is detected. In this way, the evaluation value calculating unit 214 determines the pixel signals of the fixed areas of all the reference points connected by candidate vectors to the target point that is presently evaluated, and compares each of the pixel signals with the pixel signal of the fixed area including the target point at the center.

Then, as a result of the comparison, the evaluation value calculating unit 214 selects the reference point having the fixed area that is the most similar to the pixel signal of the fixed area including the target point at the center.

Data of the candidate vector connecting the selected reference point to the target point is supplied to a vector assigning unit 215. The vector assigning unit 215 assigns the candidate to a motion vector from the target point, and outputs the assigned vector from an output terminal 15.

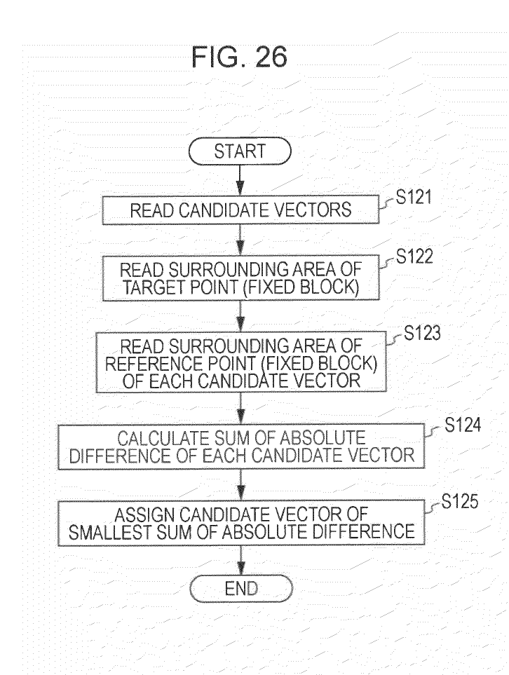

FIG. 26 is a flowchart illustrating an example of the vector determining (assigning) process performed by the configuration illustrated in FIG. 25.

With reference to FIG. 26, candidate vectors area read on the basis of the data of the evaluation value table (step S121). Then, the coordinate position of the target point corresponding the read candidate vectors is determined, and the pixel at the position (target pixel) and the pixels around the target pixel forming a fixed block are read from the target point memory 212 (step S122). Also, the coordinate positions of the reference points corresponding the read candidate vectors are determined, and the pixels at the positions (reference pixels) and the pixels around the reference pixels forming fixed blocks are read from the reference point memory 211 (step S123).

Then, the differences between the pixel levels (pixel values: luminance values) of the respective pixels in the respective fixed blocks and the pixel levels of the respective pixels in the fixed block set for the target point are calculated, absolute values of the differences are added in all the blocks, so that a sum of absolute difference is calculated (step S214). This process is performed on the reference points indicated by all the candidate vectors corresponding to the present target point.

Then, in the sum of absolute difference obtained through comparison between the target point and the plurality of reference points, the reference point having the smallest value is searched for. After the reference point having the smallest value has been determined, the candidate vector connecting the determined reference point and the target point is assigned as a motion vector for the target point (step S125).

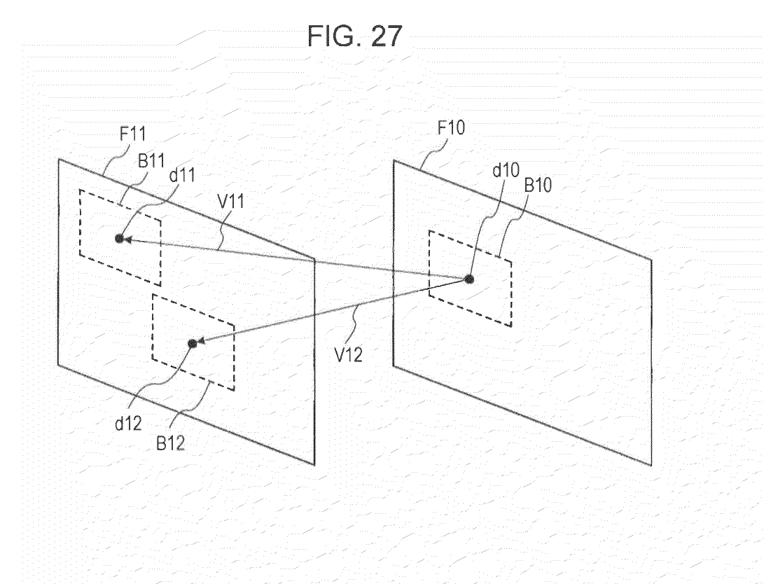

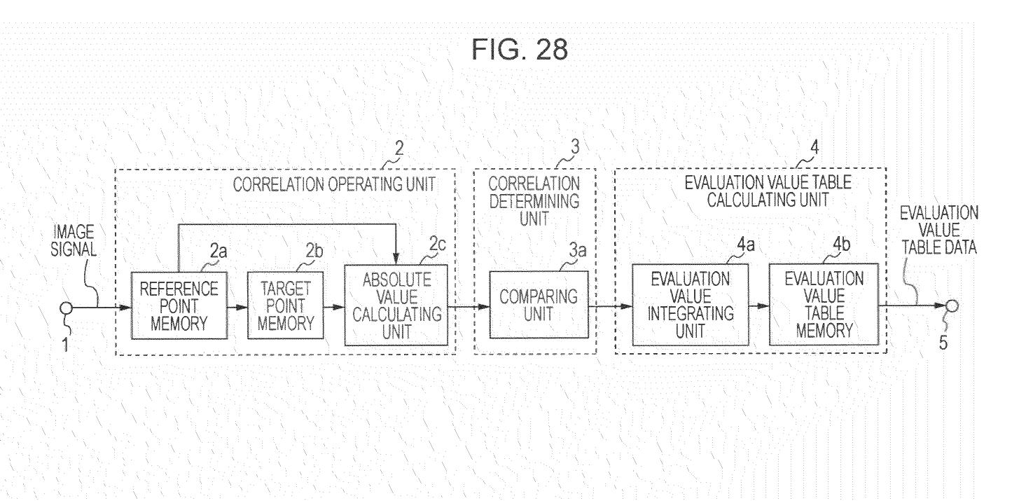

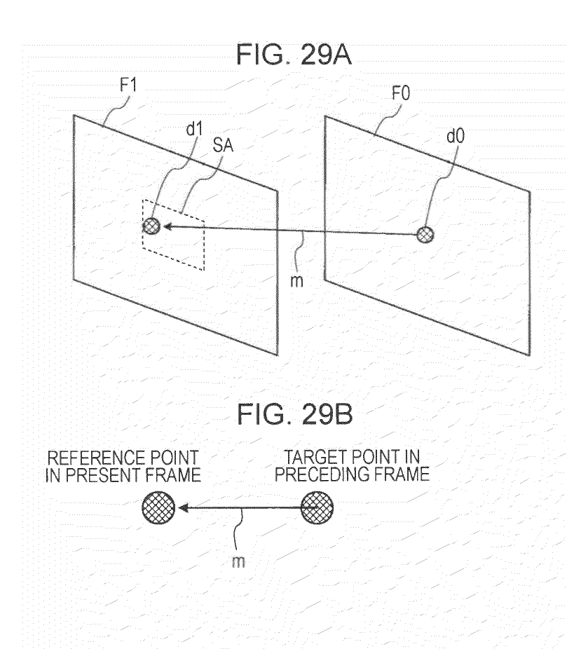

FIG. 27 illustrates an overview of the processing state in the configuration illustrated in FIG. 25 and the flowchart illustrated in FIG. 26.

In this example, a target point d10 exists in a frame F10 (target frame). Also, a plurality of candidate vectors V11 and V12 exist between the target point d10 and a frame F11 (reference frame) subsequent on the time axis. The frame F11 includes reference points d11 and d12 connected to the target point d10 by the candidate vectors V11 and V12.

Under this state illustrated in FIG. 27, a fixed block B10 including a predetermined number of pixels around the target point d10 is set in the frame F10, and the pixel values in the fixed block B10 are determined in step S122 in FIG. 26. Likewise, fixed blocks B11 and B12 including a predetermined number of pixels around the reference points d11 and d12 are set in the frame F11, and the pixel values in the fixed blocks B11 and B12 are determined in step S123 in FIG. 26.

Then, the differences between the pixel values of the respective pixels in the fixed block B11 and the pixel values of the respective pixels in the fixed block B10 are obtained, absolute values of the differences are obtained and added, and a sum of absolute difference is obtained. Likewise, the differences between the pixel values of the respective pixels in the fixed block B12 and the pixel values of the respective pixels in the fixed block B10 are obtained, absolute values of the differences are obtained and added, and a sum of absolute difference is obtained. Then, the both sums of absolute difference are compared with each other. If it is determined that the sum of absolute difference using the fixed block B11 is smaller, the candidate vector V11 connecting the reference point d11 at the center of the fixed block B11 and the target point d10 is selected. The selected candidate vector V11 is assigned as a motion vector of the target point d10.

FIG. 27 illustrates two candidate vectors to simplify the description, but actually many candidate vectors may exist for one target point. Also, FIG. 27 illustrates only one target point to simplify the description, but actually each of a plurality of representative pixels or all pixels in one frame serves as the target point.

By performing the process of determining a vector among candidate vectors in the above-described manner, a vector connecting a state of pixels around the target point and a state of pixels around the reference point similar to each other can be selected, and thus motion vectors to be assigned to respective pixels can be favorably selected.

### 17. Modification Common to Respective Embodiments

In the above-described embodiments, a process of selecting a target point is not specifically described. For example, every pixel in a frame may be sequentially selected as a target point, and motion vectors of the respective pixels may be detected. Alternatively, a representative pixel in a frame may be selected as a target point, and a motion vector of the selected pixel may be detected.

Also, regarding a process of selecting a reference point corresponding to the target point, the search area SA illustrated in FIGS. 6A and 6B is an example, and a search area of various sizes may be set to the target point.

In the above-described embodiments, the configuration of the motion vector detecting apparatus is described. Alternatively, the motion vector detecting apparatus may be incorporated in various types of image processing apparatus. For example, the motion vector detecting apparatus may be incorporated in a coding apparatus to perform high-efficiency coding, so that coding can be performed by using motion vector data. Alternatively, the motion vector detecting apparatus may be incorporated in an image display apparatus to display input (received) image data or an image recording apparatus to perform recording, and motion vector data may be used for high image quality.

The respective elements to detect motion vectors according to the embodiments of the present invention may be configured as a program, the program may be loaded into an information processing apparatus, such as a computer apparatus to process various data, and the same process as described above may be performed to detect motion vectors from an image signal input to the information processing apparatus.

The present application contains subject matter related to that disclosed in Japanese Priority Patent Application JP 2008-196611 filed in the Japan Patent Office on Jul. 30, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A motion vector detecting apparatus comprising:
an evaluation value information forming unit configured to form evaluation value information of motion vectors evaluating a possibility that a reference pixel is a candidate motion of a target pixel on the basis of pixel value correlation information between the target pixel in one of frames on a time axis in moving image data and the reference pixel in a search area in another of the frames, perform counting on at least any one of the target pixel and the reference pixel when a strong correlation is determined on the basis of the pixel value correlation information, determine an evaluation value to be added to the evaluation value information on the basis of a count value obtained through the counting, thereby forming the evaluation value information;
a motion vector extracting unit configured to extract candidate motion vectors for respective pixels in the frame of the moving image data on the basis of the evaluation value information formed by the evaluation value information forming unit; and
a motion vector determining unit configured to determine a motion vector among the candidate motion vectors extracted by the motion vector extracting unit.

2. The motion vector detecting apparatus according to claim 1,
wherein the evaluation value information forming unit sets a pixel having a count value obtained through the counting equal to or smaller than a predetermined threshold as the candidate motion, and eliminates a pixel having a count value exceeding the predetermined threshold from the candidate motion.

3. The motion vector detecting apparatus according to claim 1,
wherein the evaluation value information forming unit sets, as an evaluation value of the candidate motion, a smaller evaluation value as the count value obtained through the counting is larger, and a larger evaluation value as the count value is smaller.

4. The motion vector detecting apparatus according to claim 2,
wherein the counting is performed on both the target pixel and reference pixel.

5. The motion vector detecting apparatus according to claim 4,
wherein the evaluation value information forming unit adds, as a factor to restrict candidates to form the evaluation value information, a result of a determination made on the basis of a state about the reference pixel and the target pixel other than comparison with the threshold of the count value.

6. The motion vector detecting apparatus according to claim 5,
wherein the factor to restrict candidates to form the evaluation value information as a result of a determination made on the basis of the state about the reference pixel and the target pixel determines a candidate when a spatial inclination between the target pixel and an adjacent pixel of the target pixel has a certain value or more and when a spatial inclination between the reference pixel and an adjacent pixel of the reference pixel has a certain value or more, and does not determine a candidate in the other case.

7. The motion vector detecting apparatus according to claim 6,
wherein the spatial inclination is determined to have the certain value or more in the case where spatial inclination patterns of the target pixel and the reference pixel match each other, the spatial inclination pattern of the target pixel being obtained from a difference between a pixel value of the target pixel and a pixel value of the adjacent pixel, and the spatial inclination pattern of the reference pixel being obtained from a difference between a pixel value of the reference pixel and a pixel value of the adjacent pixel.

8. The motion vector detecting apparatus according to claim 6,
wherein the spatial inclination is determined to have the certain value or more in the case where a spatial inclination code between the target pixel and the adjacent pixel matches a spatial inclination code between the reference pixel and the adjacent pixel in a motion direction between the target pixel and the reference pixel.

9. The motion vector detecting apparatus according to claim 2,
wherein the predetermined threshold is a mode of the count value of respective pixels in a screen.

10. The motion vector detecting apparatus according to claim 2,
wherein the predetermined threshold is an average of the count value of respective pixels in a screen.

11. A motion vector detecting method comprising the steps of:
forming evaluation value information evaluating a possibility that a reference pixel is a candidate motion of a target pixel on the basis of pixel value correlation information between the target pixel in one of frames on a time axis in moving image data and the reference pixel in a search area in another of the frames,
performing counting on at least any one of the target pixel and the reference pixel when a strong correlation is determined on the basis of the pixel value correlation information when the evaluation value information is formed, determining an evaluation value to be added to the evaluation value information on the basis of a count value obtained through the counting, thereby forming the evaluation value information;
extracting candidate motion vectors for respective pixels in the frame of the moving image data on the basis of the evaluation value information; and
determining a motion vector among the candidate motion vectors extracted by the extracting.

12. A program allowing an information processing apparatus to execute:
forming evaluation value information evaluating a possibility that a reference pixel is a candidate motion of a target pixel on the basis of pixel value correlation information between the target pixel in one of frames on a time axis in moving image data and the reference pixel in a search area in another of the frames,
performing counting on at least any one of the target pixel and the reference pixel when a strong correlation is determined on the basis of the pixel value correlation information when the evaluation value information is formed, determining an evaluation value to be added to the evaluation value information on the basis of a count value obtained through the counting, thereby forming the evaluation value information;
extracting candidate motion vectors for respective pixels in the frame of the moving image data on the basis of the evaluation value information; and
determining a motion vector among the candidate motion vectors extracted by the extracting.
